(19) United States
(12) Patent Application Publication
(10) Pub. No.: US 2025/0315507 A1
(43) Pub. Date: Oct. 9, 2025

(54) SYSTEM FOR MANAGEMENT AND MONETIZATION OF PERFORMANCE AND BEHAVIORAL DATA

(71) Applicant: Bernt Erik Bjontegard, San Diego, CA (US)

(72) Inventor: Bernt Erik Bjontegard, San Diego, CA (US)

(21) Appl. No.: 18/973,035

(22) Filed: Dec. 8, 2024

Related U.S. Application Data
(60) Provisional application No. 63/608,189, filed on Dec. 9, 2023.

(51) Int. Cl. G06F 21/10; G06F 16/36; G06F 21/62; G06F 21/64

(52) U.S. Cl. CPC G06F 21/1078; G06F 16/367; G06F 21/6245; G06F 21/64

(57) ABSTRACT

A method for managing and monetizing performance data for a plurality of users is disclosed. The method involves receiving a first data set related to user performance and/or behavioral information and establishing a first communication link for secure data transfer. The received first data sets, along with additional data from various sources, are stored in a central repository. The method ensures data integrity by verifying and validating its origin and authenticity. Advanced analytics are applied to extract actionable insights, trends, and structured information, enriched with metadata such as events, locations, timestamps, and user identities. A dynamic ontology is created to contextualize and categorize the structured data. When third parties request access, the method employs smart contracts to validate requests, securely transfer data, and compensate users. This approach ensures transparency, control, and equitable monetization of user-generated performance data.

### FIELD OF THE INVENTION

The present invention relates to the field of data management, more specifically to a system to manage and monetize a plurality of user's personal and/or behavioral data using an online data management and monetization platform.

### CROSS-REFERENCE TO RELATED APPLICATIONS

This application claims the benefit of U.S. Provisional Application No. 63/608,189, filed Dec. 9, 2023, the entire contents of which are hereby incorporated by reference.

### BACKGROUND

In today's digital world, athletes have become significant contributors to an ever-expanding universe of personal performance data. This data includes a wide range of metrics, from training insights like speed, endurance, and recovery times to competitive achievements such as goals scored, successful tackles, or other in-game actions. Such data is not only valuable to the athletes themselves for self-improvement and performance tracking but also holds immense commercial and analytical value for stakeholders across the sports ecosystem. These stakeholders include sports agencies, advertisers, analytics firms, and other entities that rely on this data for purposes such as scouting talent, designing targeted marketing campaigns, and conducting in-depth performance analyses.

Despite its critical importance, athletes often find themselves excluded from the control and benefits of their performance data. Numerous third-party entities, including betting companies, video game developers, broadcasters, and content distributors, routinely access and utilize this data without proper authorization or compensation to the athlete. This misuse is prevalent across various industries that profit substantially from athletes' performance metrics, making fortunes by exploiting this data without sharing any proceeds with the rightful owners—the athletes.

The absence of a secure, standardized, and athlete-centric system to govern the collection, access, and monetization of personal performance data has created a significant gap in the sports industry. Athletes are left in a precarious position, lacking the means to oversee how their data is gathered, who uses it, and for what purposes. This lack of control not only undermines athletes' rights to privacy and ownership but also denies them the opportunity to gain equitable financial benefits from the utilization of their data.

Moreover, this unregulated landscape presents risks beyond financial inequity. Unauthorized or unethical use of personal performance data can lead to privacy breaches and reputational harm, further highlighting the urgent need for a robust framework to address these issues. Current approaches fail to account for the unique challenges associated with managing athlete-generated data, such as ensuring accuracy, protecting sensitive information, and distributing proceeds fairly.

### SUMMARY

The present invention relates to the field of data management and monetization, more specifically to a system to manage and monetize a plurality of user's personal and/or behavioral data using an online data management and monetization platform. The system is directed toward empowering users, especially athletes, but not limited, by providing them with a secure, transparent, and monetizable framework through which they can exercise control over their personal performance data and behavioral data.

In one aspect of the present invention, a system is disclosed to manage and monetize a plurality of user's personal and/or behavioral data using the online data management and monetization platform. The first data sets include at least one performance, and/or behavioral information, including, user age, position, performance, level, playtime, projected potential level, experience, number of games played, number of minutes played, experience in domestic/national leagues, and contract situation. A back-end server is communicably connected to one or more data collection units via a first communication medium. Further, a data ingestion module is adapted to receive the first data sets from the plurality of data collection units, and a plurality of second data sets from a plurality of data sources and subsequently stored within a central repository. The second data sets include user historical data, biometric data, fan engagement data, tracking data, and team performance data. Further, a data authentication module is adapted to verify and validate the origin and the integrity of collected first data sets and the plurality of second data sets. A data analysis module is adapted to analyze the ingested data sets to extract actionable insights, trends, and patterns from there and transform the ingested data into structured information with corresponding metadata including but not limited to event, location, time, and individual identity. Again, an ontology generator is adapted to create and maintain a dynamic ontology for the ingested data sets. This structured information is categorized and contextualized in accordance with the dynamic ontology. Further, a data exchange platform communicably connected to the backend server via a second communication medium, the data exchange platform adapted to receive contextualized data from the backend server. The first and second communication medium include 5G, private 5G, 6G, Wi-Fi, BLT and beacons, WiFi-6, LPWA, Peer to Peer, Audio, Voice, Alexa, Siri, Google Voice, POS, and Scanners. Finally, when a third party requests access to a user's performance data, the data exchange platform automatically executes a smart contract, validates the request, facilitates secure data transfer to the third party, and compensates the corresponding user.

In another aspect of the present invention, a process to manage and monetize a plurality of user's personal and/or behavioral data using the online data management and monetization platform is disclosed. A first data set is received from one or more users which pertain to at least one performance, and/or behavioral information of one or more of the plurality of users. The first data sets include at least one performance, and/or behavioral information, including, user age, position, performance, level, playtime, projected potential level, experience, number of games played, number of minutes played, experience in domestic/national leagues, and contract situation. A communicable connection is established to transfer the first data sets received via, a first communication medium. The first and second data sets are received from a plurality of data sources that are subsequently stored in a central repository. The second data sets include user historical data, biometric data, fan engagement data, tracking data, and team performance data. Further, the collected first and second data sets are verified are validated to confirm the origin and integrity of the datasets. Analysis is performed on the ingested first and second data sets to extract actionable insights, trends, and patterns from there and transform the ingested data into structured information with corresponding metadata including but not limited to event, location, time, and individual identity. Further, a dynamic ontology is created for the ingested first data sets and the plurality of second data sets. This structured for the ingested first data sets and the plurality of second data sets. Again, a communicable connection is established via, a second communication medium to receive contextualized data. The first and second communication medium include 5G, private 5G, 6G, Wi-Fi, BLT and beacons, WiFi-6, LPWA, Peer to Peer, Audio, Voice, Alexa, Siri, Google Voice, POS, and Scanners. Finally, when a third party requests access to a user's performance data, a smart contract is automatically executed that validates the request, facilitates secure data transfer to the third party, and subsequently provides compensation to the corresponding user.

In an aspect, the generated dynamic ontology continuously evolves based on updated user personal data, user behavioral data inputs, and human expert feedback.

In yet another aspect, the data analysis module includes machine learning algorithms capable of dynamically updating data transformations and tagging lineage as new insights are generated.

Advantageously, the system comprises a notification module notifying the plurality of users about the user's performance data access requests and proposed usage agreements, and any detected anomalies or unauthorized access attempts.

### BRIEF DESCRIPTION OF THE ACCOMPANYING DRAWINGS

The above-mentioned implementations are further described herein regarding the accompanying figures. It should be noted that the description and figures relate to exemplary implementations and should not be construed as a limitation to the present disclosure. It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

FIG. 1 depicts an exemplary system to manage and monetize a plurality of user's personal and/or behavioral data using the online data management and monetization platform.

FIG. 2 depicts details of the plurality of the user's personal data and/or behavioral data.

FIG. 3 depicts details of the devices and the plurality of sources from where the user's personal data and/or behavioral data is received.

FIG. 4 depicts details of the first and second communication mediums using which the communication is established between various components.

FIG. 5 depicts how the user performance and/or behavior data is ingested into the data ingestion module and subsequently stored in the centralized repository.

FIG. 6 depicts exemplary sub-modules of a data analytics module.

FIG. 7 depicts an exemplary sub-module within the ontology generator module.

FIG. 8 depicts exemplary sub-modules within the data exchange platform.

FIG. 9 depicts details of the contextualized data.

FIG. 10 depicts relationship between the user's performance data and/or behavioral data and the backend server.

FIG. 11 depicts generation of ontology by utilizing the user's performance data and/or behavioral data.

FIG. 12 depicts the collection and monetization of the user's performance and/or behavioral data.

FIG. 13 depicts monetization of fan relationship by utilizing data collected from the fan experience.

FIG. 14 depicts athletes predicted performance based on the captured user's performance and/or behavioral data.

FIG. 15 depicts an exemplary user interface disclosing a finance model for athletes designed to manage and track the monetary aspects of an athlete's personal performance data and other revenue-generating activities.

FIG. 16 depicts an exemplary process to manage and monetize a plurality of users' personal and/or behavioral data using the online data management and monetization platform.

FIG. 17 depicts an exemplary embodiment utilizing data input to generate an output using various machine learning techniques.

### DETAILED DESCRIPTION

Embodiments, of the present disclosure, will now be described with reference to the accompanying drawing.

In the following description, certain specific details are outlined to provide a thorough understanding of various disclosed embodiments. However, one skilled in the relevant art will recognize that embodiments may be practiced without one or more of these specific details, or with other methods, components, materials, etc.

Unless the context indicates otherwise, throughout the specification and claims which follow, the word “comprises” and variations thereof, such as, “comprises” and “comprising” are to be construed in an open, inclusive sense that is as “including, but not limited to.” Further, the terms “first,” “second,” and similar indicators of the sequence are to be construed as interchangeable unless the context clearly dictates otherwise.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content dictates otherwise. It should also be noted that the term “° or” is generally employed in its broadest sense, that is, as meaning “and/or” unless the content dictates otherwise.

A system is disclosed to manage and monetize a plurality of user's personal and/or behavioral data using the online data management and monetization platform. The first data sets include at least one performance, and/or behavioral information, including, user age, position, performance, level, playtime, projected potential level, experience, number of games played, number of minutes played, experience in domestic/national leagues, and contract situation. A back-end server is communicably connected to one or more data collection units via a first communication medium. Further, a data ingestion module is adapted to receive the first data sets from the plurality of data collection units, and a plurality of second data sets from a plurality of data sources and subsequently stored within a central repository. The second data sets include user historical data, biometric data, fan engagement data, tracking data, and team performance data.

Further, a data authentication module is adapted to verify and validate the origin and the integrity of collected first data sets and the plurality of second data sets. A data analysis module is adapted to analyze the ingested data sets to extract actionable insights, trends, and patterns from there and transform the ingested data into structured information with corresponding metadata including but not limited to event, location, time, and individual identity. Again, an ontology generator is adapted to create and maintain a dynamic ontology for the ingested data sets. This structured information is categorized and contextualized in accordance with the dynamic ontology.

Further, a data exchange platform communicably connected to the backend server via a second communication medium, the data exchange platform adapted to receive contextualized data from the backend server. The first and second communication medium include 5G, private 5G, 6G, Wi-Fi, BLT and beacons, WiFi-6, LPWA, Peer to Peer, Audio, Voice, Alexa, Siri, Google Voice, POS, and Scanners. Finally, when a third party requests access to a user's performance data, the data exchange platform automatically executes a smart contract, validates the request, facilitates secure data transfer to the third party, and compensates the corresponding user.

The invention offers significant advantages by providing a secure, transparent, and user-centric framework for data management and monetization. It ensures the integrity, authenticity, and privacy of user data through advanced modules for validation, dynamic ontology generation, and blockchain-backed data exchange. Users are empowered to control access to their data, with features such as real-time notifications, smart contract automation, and a user-friendly interface for authorizing or denying requests. The system promotes fair compensation for data owners, supports regulatory compliance, and facilitates seamless integration with diverse stakeholders like broadcasters, advertisers, and sponsors. Additionally, it enhances data utility through advanced analytics and predictive insights while maintaining continuous updates and collaboration between AI and human expertise. This makes the invention a robust solution for securely leveraging user data across interconnected ecosystems, particularly in sports and performance-driven industries.

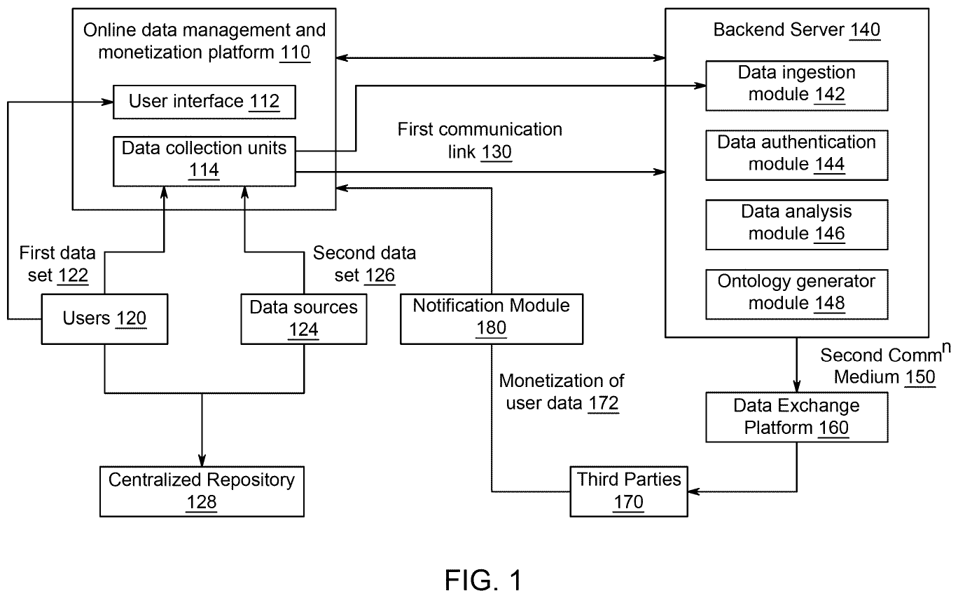

FIG. 1 depicts an exemplary system 100 to manage and monetize a plurality of user's personal and/or behavioral data using the online data management and monetization platform 102.

The system 100 is a robust and dynamic framework designed to collect, process, and analyze comprehensive performance and behavioral data from a diverse set of users 120. At its core, the system 100 utilizes a plurality of data-collection units 114, each uniquely equipped to capture a first data set 122 that provides detailed insights into individual user metrics. The data collection unit 114 is integrated within an online data management and monetization platform 110.

The first data set 122 includes but is not limited to, user age, position, performance levels, playtime, projected potential levels, experience, the number of games played, minutes spent playing, experience in domestic and national leagues, and contract situations. Together, these parameters enable a thorough understanding of the user's current abilities and potential future trajectory.

To ensure seamless data acquisition, the system 100 incorporates cutting-edge technologies across its data collection units 114. IoT sensors are deployed to monitor physiological and environmental metrics in real-time, enabling precise tracking of user activity and condition. Edge devices facilitate localized data processing, minimizing latency and ensuring real-time responsiveness. Mobile devices such as cell phones and wearable devices provide continuous data collection, ensuring portability and flexibility in diverse contexts. High-resolution cameras and video equipment capture visual data for motion analysis and behavioral assessment, offering deeper insights into user activities.

The system 100 also integrates sports-specific monitoring equipment, optimized for capturing domain-specific metrics that are crucial for analyzing athletic performance. To expand its capabilities beyond immediate environments, system 100 employs smart city sensors to gather contextual data, such as environmental conditions, that may impact user performance. Additionally, kiosks and POS systems enhance data capture in commercial or event settings, while digital signage gathers user interaction data in public and semi-public spaces.

Furthermore, system 100 is augmented with immersive technologies, including virtual reality (VR), augmented reality (AR), extended reality (XR), and mixed reality (MR) tools. These enable the capture of user interactions in simulated environments, providing a richer dataset for analysis. By utilizing this broad and sophisticated network of data-collection units 114, the system 100 ensures a comprehensive, multi-dimensional approach to data acquisition, enabling highly accurate and actionable insights into user performance and behavior.

The system 100 includes a back-end server 140 that is strategically designed to serve as the central hub for data processing, storage, and analysis. This back-end server 140 is communicably connected to the plurality of data-collection units 114 via a robust and versatile first communication medium 130. This connection ensures seamless and real-time data transfer from the data-collection units 114 to the backend server 140, enabling the aggregation and processing of vast amounts of performance and behavioral data from users 120.

The first communication medium 130 incorporates a comprehensive array of advanced communication technologies, ensuring flexibility, reliability, and adaptability across diverse operational scenarios. High-speed wireless networks such as 5G, private 5G, and 6G provide ultra-fast and low-latency connectivity, essential for handling large volumes of real-time data, particularly in scenarios involving high-resolution video feeds or detailed biometric data. These technologies enable the data collection units 114 to transmit information rapidly and securely to the back-end server, even in high-demand environments.

In addition to cutting-edge cellular networks, the first communication medium 130 also incorporates Wi-Fi and Wi-Fi-6 technologies, offering dependable and high-capacity connections in local environments. For short-range communication, Bluetooth (BLT) and beacon technology provide efficient, low-energy solutions ideal for wearable devices or proximity-based data collection scenarios.

The first communication medium 130 also includes Low Power Wide Area (LPWA) technologies, designed to support long-range and low-power IoT devices. These are particularly useful for data-collection units 114 deployed in remote or resource-constrained locations. Peer-to-peer (P2P) communication ensures direct and decentralized data sharing between devices, enhancing first communication medium 130 redundancy and enabling local interactions without the need for centralized networks.

To accommodate voice-enabled and audio-based interfaces, the first communication medium 130 integrates communication mediums like Alexa, Siri, Google Voice, and audio recognition technologies, allowing for hands-free data transmission and interaction. Additionally, the inclusion of Point-of-Sale (POS) systems and scanners extends the communication capabilities to commercial and transactional contexts, enabling data collection during user interactions with payment systems or digital check-ins.

This robust and multi-faceted communication infrastructure ensures that the back-end server 140 is equipped to receive data seamlessly from a wide variety of collection units, regardless of the environment or application. The secure and efficient transfer of data enables the back-end server 140 to function as the central repository 128 and processing unit, supporting the system's goals of delivering actionable insights and personalized recommendations based on user data.

The system 100 includes a data ingestion module 142 that plays a critical role in aggregating and organizing diverse data streams. The data ingestion module 142 is integrated within the backend server 140. The data ingestion module 142 is specifically designed to receive two distinct categories of data: the first data set 122 collected from a plurality of data collection units 114 and the second data set 126 obtained from a variety of data sources 124. By seamlessly integrating and processing these datasets, the data ingestion module 142 ensures a holistic and comprehensive representation of user information.

The first data set 122 primarily comprises real-time performance and behavioral information captured from advanced data collection units such as IoT sensors, edge devices, wearable technologies, cameras, and sports-specific monitoring equipment. The first data set 122 include details such as user metrics, game statistics, biometric readings, and situational context that provide a snapshot of the user's current performance and behavior.

The second data set 126 provides complementary insights by pulling from a plurality of external data sources 124, including third-party databases that house historical data, user profiles, team profiles, and even social media interactions. The data sources 124 enrich the system's data repository by adding context and depth. For example, historical data may include digitized records such as scorecards and performance logs, enabling the integration of past achievements and trends into the analysis. This historical integration ensures a more detailed understanding of the user's growth trajectory and potential.

The data ingestion module 142 is further adapted to store these datasets within a centralized repository 128 that acts as a unified, structured database. A defining feature of the centralized repository 128 is its real-time updating capability. Both the first data set 122 and second data set 126 are continuously updated to reflect the latest user inputs, interactions, and contextual changes. This dynamic updating mechanism ensures that the data repository remains current and relevant, allowing for the generation of accurate, actionable insights.

This real-time synchronization not only enables the data ingestion module 142 to support instantaneous decision-making but also maintains the integrity and consistency of the stored data. Whether it's real-time performance metrics from wearable devices or updated fan engagement data from social media, the data ingestion module 142 ensures that all information is systematically collected, categorized, and contextualized for downstream processing and analysis. This robust architecture underpins the data ingestion module 142 ability to deliver personalized recommendations, predictive insights, and enhanced user engagement across various applications.

The system 100 incorporates a data authentication module 144 designed to ensure the authenticity, accuracy, and reliability of the data processed within the online data management and monetization platform 102. The data authentication module 144 is specifically responsible for verifying and validating the origin and integrity of the collected data sets, which include both the first data set 122 and the second data set 126. The first data set 122 typically captures real-time performance and behavioral metrics through various data collection units such as IoT sensors, wearable devices, cameras, and other monitoring tools. The second data set 126, obtained from external sources like third-party databases, social media platforms, and historical archives, provides enriched contextual data, including user profiles, team performance metrics, and historical records.

The data authentication module 144 performs two critical functions. First, it verifies the origin of the data, ensuring that the information is sourced only from trusted and authorized devices or third-party platforms. For example, the data authentication module 144 confirms that biometric data is collected from approved wearables or IoT devices and that historical performance data is retrieved from authenticated databases. This step prevents the integration of data from unknown or unverified sources, safeguarding the system from potential inaccuracies or fraudulent entries.

Second, the data authentication module 144 validates the integrity of the data by employing advanced cryptographic techniques and integrity-checking protocols. These methods include calculating cryptographic hashes, verifying digital signatures, and employing blockchain-based tracking mechanisms. By doing so, the data authentication module 144 ensures that data remains intact and unaltered during transmission or storage. Each data point is associated with an immutable lineage and pedigree, documenting its origin, any transformations, and analyses it has undergone. This traceability is essential for ensuring data accuracy, building trust, and supporting compliance with industry regulations.

The data authentication module 144 operates seamlessly within the online data management and monetization 102, utilizing secure content delivery networks (CDNs), encryption protocols, and blockchain technology. This ensures that the data authentication module 144 not only prevents unauthorized access or tampering but also maintains a robust audit trail for all data points. By verifying and validating data at every stage, the data authentication module 144 supports other system functionalities such as predictive analytics, ontology creation, and personalized recommendations. Ultimately, the data authentication module 144 enhances the overall reliability and ethical use of the online data management and monetization platform 102 by ensuring that all data utilized is both authentic and accurate.

The data analysis module 146 is a core component of the system 100, designed to process and analyze the ingested data sets to generate actionable insights and meaningful patterns. The data analysis module 146 is integrated within the backend server 140. The data analysis module 146 operates on data received from various sources, such as IoT devices, wearables, third-party databases, and historical archives, which are ingested into the centralized repository 128. By applying advanced analytical techniques, the data analysis module 146 transforms raw data into structured information enriched with metadata attributes such as event type, location, time, and individual identity. This structured representation of data is critical for enabling downstream processes like reporting, visualization, and decision-making.

The data analysis module 146 comprises two specialized sub-modules, namely, an insights generation sub-module, and a predictive analysis sub-module.

The insights generation sub-module is responsible for identifying patterns and trends in the data. For instance, the insights generation sub-module can detect correlations between an athlete's sleep patterns and performance metrics or trends in fan engagement during specific sporting events. By utilizing statistical models, clustering algorithms, and association rule mining, the insights generation sub-module organizes data into comprehensible insights. These insights help stakeholders, such as coaches or teams, make informed decisions regarding training schedules, player rotations, or marketing strategies.

The predictive analysis sub-module uses advanced forecasting techniques to predict future outcomes. For example, the predictive analysis sub-module can estimate an athlete's performance metrics, such as projected game scores, fitness levels, or injury risks, based on historical and real-time data. Machine learning models, such as regression analysis, neural networks, and generative models, are employed to deliver accurate and dynamic predictions. Importantly, the processed data maintains its connection to the source user profile, ensuring traceability and personalized output.

Additionally, the data analysis module 146 is powered by machine learning algorithms that continuously improve its functionality. As new data is ingested and analyzed, the algorithms dynamically update data transformations, metadata tagging, and lineage tracking. This ensures that the analysis evolves in real-time, reflecting the latest data trends and maintaining relevance. For example, if a new pattern in fan behavior is detected, the predictive analysis sub-module can immediately adjust its tagging framework to include this new trend.

The data analytics module 146 not only provides valuable insights but also ensures the traceability of the information back to its origin. This is achieved through metadata tagging and lineage tracking, which document the transformations and analyses applied to the data. This transparency supports compliance with data governance policies and builds trust among users, ensuring that the data is used ethically and responsibly.

The ontology generator module 148 is a sophisticated component designed to structure and contextualize the ingested data sets into a dynamic and evolving ontology. The ontology generator module 148 plays a crucial role in ensuring that the data is not only categorized meaningfully but also contextualized to provide a deeper understanding of the relationships, patterns, and insights embedded within the data. The dynamic ontology serves as a structured knowledge framework that organizes the data into categories and contexts that are relevant to the users and the system's objectives.

At the core of the ontology generator module 148, is the data pedigree tracking submodule, which meticulously documents the complete lifecycle of the ingested data sets. This includes capturing the origin, transformations, analyses, and usage of each piece of data. By maintaining a comprehensive lineage, the data pedigree tracking submodule ensures traceability, accountability, and transparency in data handling. For instance, the data pedigree tracking submodule can track how an athlete's performance data has been analyzed over time, linking it back to its sources, such as IoT sensors or wearable devices.

The ontology generator module 148 is designed to evolve dynamically, adapting to continuous inputs from multiple sources. These inputs include updates to user personal data, such as age or skill level, user behavioral data, such as training patterns or social interactions, and feedback from human experts, such as coaches or analysts. By integrating these inputs, the ontology remains current, relevant, and actionable, reflecting the latest trends and information.

Moreover, the ontology generator module 146 provides a collaborative relationship between AI analysis and human expertise. While AI algorithms identify patterns, relationships, and anomalies within the data, human experts provide detailed insights, domain-specific knowledge, and contextual refinements. This collaboration ensures that the ontology is both technically robust and practically applicable, addressing the unique needs of the users and stakeholders. For example, an AI model might identify correlations between an athlete's nutrition and recovery time, while a human expert can validate and refine these findings to align with real-world practices.

The generated ontology not only categorizes the data but also contextualizes it by establishing relationships between various data points. For example, it might link an athlete's training session data with their biometric data, weather conditions, and historical performance, providing a comprehensive view of the factors influencing their performance. This contextualization enhances the system's ability to generate actionable insights and personalized recommendations.

Additionally, the dynamic ontology continuously evolves as new data and insights become available. For example, when a new training metric or performance parameter is introduced, the ontology adapts to include and categorize this new information, ensuring that the system remains flexible and forward-looking. This adaptability makes the module particularly valuable in dynamic fields like sports and performance analytics, where the parameters of success and metrics of interest frequently change.

The data exchange platform 160 is an integral component of the system 100, designed to facilitate seamless data transactions while ensuring transparency, security, and compliance. The data exchange platform 160 is communicably connected to the backend server 140 via a second communication medium 150, which includes advanced communication technologies such as 5G, private5G, 6G, Wi-Fi, WiFi-6, LPWA, and various other mediums like Bluetooth (BLT), beacons, Peer to Peer, as well as audio-based interfaces such as Alexa, Siri, and Google Voice. This versatile communication infrastructure ensures that data flows smoothly and efficiently between the backend server 140 and the data exchange platform 160, regardless of location or device used.

The primary function of the data exchange platform 160 is to receive contextualized data from the backend server 140, which has already undergone analysis, transformation, and contextualization. This enables stakeholders to access enriched, actionable data that is in correspondence with specific needs or objectives. For instance, broadcasters might receive performance data of athletes, while advertisers can access audience engagement metrics.

Within the data exchange platform 160, several critical sub-modules, namely a distribution sub-module, rights management sub-module, regulatory compliance sub-module, blockchain integration, multi-tenant access control, data monetization module, and smart contract generation module that ensure the smooth operation of the system 100. These sub-modules are explained in detail in the following figures.

The distribution sub-module is responsible for automating the distribution of compensation to data owners. When a third party 170 accesses and uses the data, the data exchange platform 160 ensures that the creators or owners of the data receive their fair share of the revenue generated from its use. This is an essential part of the system's data monetization.

The rights management sub-module controls data access permissions, ensuring that only authorized parties can access specific data sets. The rights management sub-module enforces clear rules about who can view or use the data, based on predefined agreements. This adds a layer of security and privacy, ensuring that only the right parties are granted access to sensitive or valuable data.

The regulatory compliance sub-module maintains legal and ethical standards and ensures that all data transactions adhere to relevant privacy laws and regulations. The regulatory compliance sub-module guarantees compliance with local and international regulations such as GDPR, HIPAA, or other industry-specific standards. This is especially important in sectors such as sports where data privacy and the protection of personal information are paramount.

The blockchain integration records all transactions within the data exchange platform 160, ensuring full transparency and accountability. This decentralized ledger ensures that all data exchanges are immutable and auditable, providing a secure record of all activities for verification, dispute resolution, and compliance tracking.

In addition to these core features, the data exchange platform 160 incorporates several other advanced functionalities:

The multi-tenant access control system is designed to manage the different access levels of various stakeholders. Different parties, such as broadcasters, advertisers, or sports teams, can have personalized access based on their roles, ensuring that each entity interacts with the data according to their specific permissions. This helps prevent unauthorized access and ensures the proper segregation of duties.

The data monetization module facilitates a variety of transaction types, allowing stakeholders to buy, sell, or exchange data as part of a broader data economy. For example, sports teams may sell performance data, while advertisers may buy fan engagement data to target specific audiences more effectively. The data monetization module allows for these transactions to be conducted in a streamlined, efficient, and profitable manner.

The smart contract generation module incorporates smart contracts that automatically create data usage agreements between parties. These contracts specify the terms of data access, including the scope of usage, compensation, and duration. The automation of these contracts ensures that agreements are executed without the need for intermediaries, reducing operational complexity and the potential for disputes.

Finally, the stakeholders involved in the data exchange platform 160 include a diverse range of entities, such as broadcasters, betting entities, bookmakers, fantasy leagues, streamers, radio stations, social media networks, and advertisers. These parties rely on the data exchange platform 160 to access real-time data for a variety of purposes, including content creation, targeted marketing, performance tracking, and more. The design of the data exchange platform 160 enables these stakeholders to seamlessly interact with data, ensuring that all parties can extract value from the system 100 while adhering to the agreed-upon rules and regulations.

The data exchange platform 160 is a comprehensive and secure system that facilitates the seamless flow of contextualized data between various stakeholders in the sports and entertainment ecosystem. By utilizing cutting-edge communication technologies, blockchain for transparency, and smart contracts for automation, the platform ensures efficient, secure, and compliant data transactions while enabling fair compensation for data owners.

When a third party 170 requests access to a user's performance data, the data exchange platform 160 plays a crucial role in ensuring that the transaction is secure, transparent, and fair. Upon receiving the access request, the online data exchange platform 160 automatically triggers the execution of a smart contract. This smart contract is responsible for validating the request, and ensuring that the third party 170 is authorized to access the data. The contract also specifies the terms of the data usage, including compensation for the data owner. Once the request is validated, the data exchange platform 160 facilitates the secure transfer of the requested data to the third party. Simultaneously, the corresponding user 120 (data owner) is automatically compensated according to the agreed terms outlined in the smart contract, ensuring that their rights are respected and they receive appropriate compensation for their data.

To maintain transparency and communication, the data exchange platform 160 is operatively coupled with a notification module 180 that keeps all involved users 128 informed about data access requests. The notification module 180 sends real-time alerts to user 128 whenever a third party 170 requests access to their performance data. The notification also includes details about the proposed usage agreements, allowing users 128 to review and understand how their data will be utilized. Additionally, the notification module 180 is designed to detect and alert users about any anomalies or unauthorized access attempts, providing an added layer of security and control over their data. This ensures that users are aware of any potential breaches or misuse of their data, and can take necessary actions to safeguard their privacy.

To further enhance user control and transparency, the online data management and monetization platform 102 integrates a user interface 112 within it. The user interface 112 allows users to not only view access requests but also authorize or deny access to their data. Through the user interface 112, users 120 can track the lineage and transformation history of their data, providing them with insight into how their data has been processed, stored, and shared. By offering this level of visibility, users can make informed decisions about whether to grant access to their data and ensure that their personal information is handled according to their preferences.

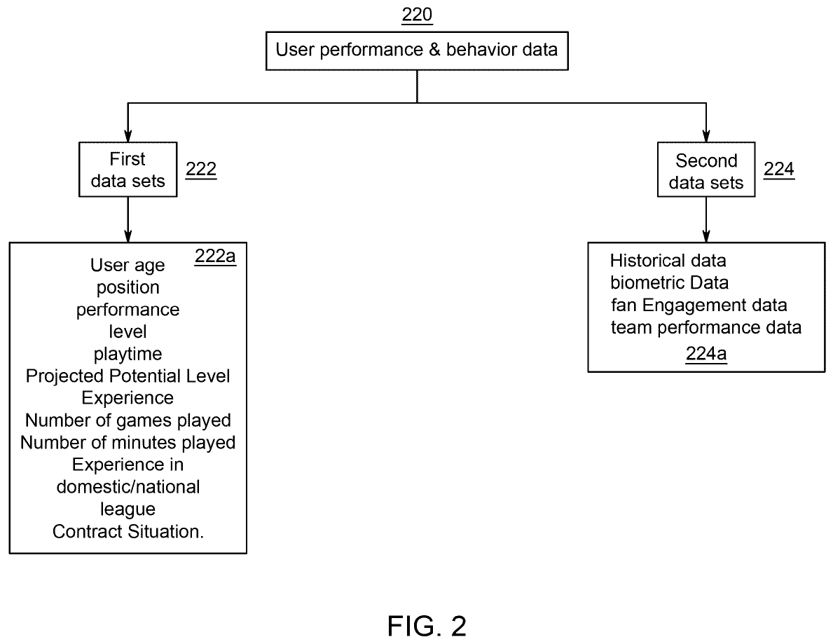

FIG. 2 depicts details of the plurality of the user's personal data and/or behavioral data 220.

The user performance and/or behavior data 220 is a comprehensive collection of information capturing various aspects of a user's athletic profile and activities. The user performance and/or behavior data 220 is divided into two primary categories: the first data set 222 and the second data set 224, each providing distinct but complementary insights.

The first data set 222 focuses on the core characteristics and performance metrics of the user. They include details 222a such as the user's age, which provides context for developmental potential and career trajectory; position, which is critical for role-specific performance analysis; and overall performance, including skill ratings and achievements. The user performance and/or behavior data 220 also encompasses playtime metrics, such as the total number of games played and minutes spent on the field, which reflect the user's experience and endurance. Additional details include the user's projected potential level, offering a predictive assessment of future capabilities, and experience in domestic or national leagues, which highlights exposure to competitive environments. Contract situation data captures the user's current contractual obligations and status, adding another layer of value for stakeholders like teams and scouts.

The second data set 224 complements the first data set 222 by incorporating a broader and more dynamic range of details 224a. Historical data provides a longitudinal view of the user's performance trends, enabling an in-depth analysis of progress and patterns over time. Biometric data, derived from wearables and sensors, offers real-time insights into physical attributes like heart rate, stamina, and recovery rates. Fan engagement data sheds light on the user's popularity and marketability by quantifying fan interactions and social media presence. Tracking data captures movement and positional information during gameplay, offering detailed metrics on speed, agility, and spatial awareness. Team performance data places the user within the context of the collective team effort, providing insights into how the user's actions contribute to or are influenced by team dynamics.

Together, these first data sets 222, and second data sets 224 provide a complete view of the user, combining static and dynamic elements to support applications in talent evaluation, performance optimization, marketing, and more.

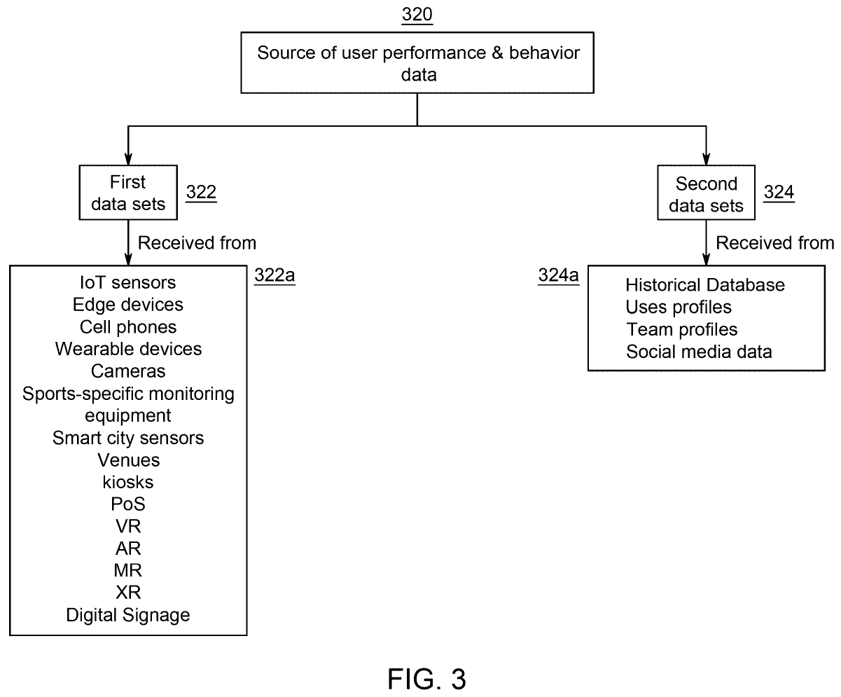

FIG. 3 depicts details of the devices and the plurality of sources from where the user's personal data and/or behavioral data is received.

The data collection units collect user performance and/or behavioral data 320 from diverse sources to form the first data set 322 and the second data set 324. These datasets are integral to providing a comprehensive analysis of user performance and behavior.

The first data set 322 originates from a range of advanced devices 322a that capture real-time and contextual information directly from the user's environment. These include IoT sensors and edge devices, which monitor metrics like speed, motion, and environmental conditions. Cell phones and wearable devices, such as fitness trackers and smartwatches, provide data on the user's physiological parameters like heart rate, step count, and activity level. Cameras and sports-specific monitoring equipment record detailed performance metrics such as movement patterns, accuracy, and skill execution during games or training sessions. Advanced systems like smart city sensors, venues, and kiosks contribute by capturing location-specific or infrastructure-related data, such as crowd density and environmental conditions at event locations. Point-of-sale (POS) systems offer insights related to transactions or attendance. Immersive technologies like Virtual Reality (VR), Augmented Reality (AR), Mixed Reality (MR), and Extended Reality (XR) add layers of interaction, enabling the collection of user behavior in simulated or augmented environments. Additionally, digital signage and interactive boards track engagement and interaction levels during events.

The second data set 324, on the other hand, comes from a broader range of aggregated sources like the third-party database that includes details 324a like historical data, user profiles, team data, and social media data. Historical data contribute legacy data about the user's past performance, enabling trends and long-term analysis. User profiles store personalized information, such as preferences, achievements, and career milestones, creating a holistic view of individual users. Team profiles provide contextual data on the collective performance of groups, offering insights into collaboration, synergy, and team dynamics. Lastly, social media platforms contribute behavioral data, capturing user interactions, fan engagement, and public sentiment. This source adds a dynamic layer of social context, illustrating how users are perceived and engage with their audience or community.

Together, these diverse sources ensure that the first data set 322 and the second data set 324 comprehensively capture real-time, historical, personal, and contextual information 324a. This multidimensional approach supports robust data analysis, enabling actionable insights in correspondence to individual users and broader applications.

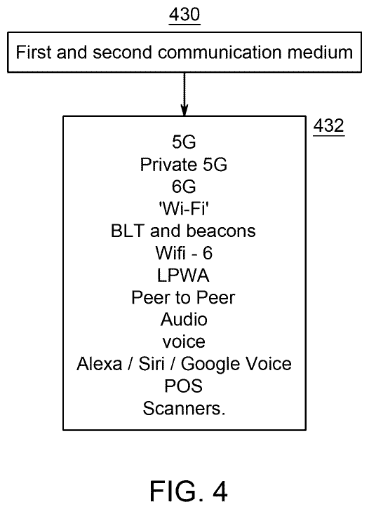

FIG. 4 depicts details of the first and second communication mediums 430 using which the communication is established between various components.

The first and second communication mediums 430 serve as crucial channels for transferring data within the system 100, ensuring secure, efficient, and seamless connectivity across various entities and environments. These mediums encompass a broad range of advanced technologies 432 that cater to different data transfer needs and operational contexts.

Technologies such as 5G and Private 5G provide high-speed and low-latency connectivity, making them ideal for real-time data exchange, including the transmission of performance metrics and biometric updates. Private 5G further enhances security and control, offering a dedicated network for enterprise-level applications where data privacy and exclusivity are critical. 6G, an emerging technology, holds the promise of unprecedented data speeds, greater bandwidth, and ultra-low latency, enabling future-ready capabilities for massive data handling and rapid processing.

Wi-Fi and Wi-Fi 6 are widely used for their flexibility and availability. Wi-Fi 6a, in particular, improves network efficiency and connectivity in dense environments, making it suitable for large-scale deployments. BLT Bluetooth Low Energy and Beacons offer localized data transfer, ideal for proximity-based services and communication between devices within a short range.

For long-range and low-power needs, LPWA (Low Power Wide Area) networks are utilized, especially for IoT devices, enabling efficient communication in scenarios requiring minimal power consumption. Peer-to-peer communication facilitates direct device-to-device connections, ensuring decentralized and independent data transfer without relying on central infrastructure.

Voice-controlled technologies, including Alexa, Siri, and Google Voice, allow users to interact with the system through natural language, enhancing accessibility and user convenience. Additionally, audio and voice-based channels provide alternative modes of communication, especially in environments where text or visual interfaces are impractical.

Finally, POS (Point of Sale) systems and scanners enable seamless integration with transactional and identification processes, ensuring data exchange during purchases or identity verification. Together, these diverse first and second communication mediums 430 make the system 100 highly adaptable and capable of operating efficiently in a variety of use cases, catering to real-time needs and ensuring robust, multi-modal connectivity.

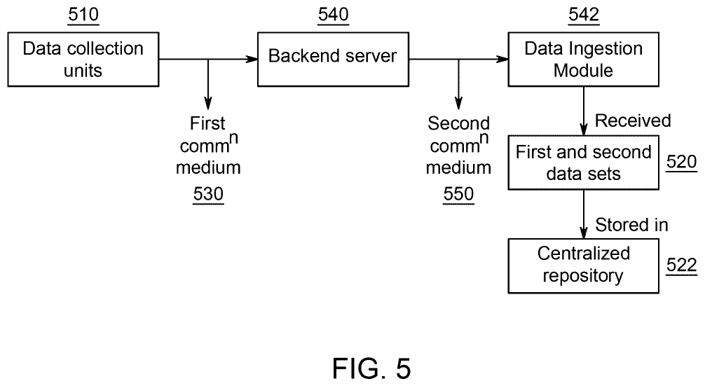

FIG. 5 depicts how the user performance and/or behavior data is ingested into the data ingestion module 542 and subsequently stored in the centralized repository 522.

FIG. 5 illustrates the acquisition, transfer, and storage of user performance and behavioral data through a sophisticated architecture. User performance and/or behavioral data is initially collected by data collection unit 510, which incorporates a variety of devices such as IoT sensors, edge devices, cell phones, wearable technology, cameras, sports-specific monitoring equipment, and other advanced tools. The data collection unit 510 captures real-time metrics like performance statistics, positional data, and user interaction within environments such as smart city sensors, venues, kiosks, or even immersive technologies like VR, AR, XR, MR, and digital signage.

Once collected, the user performance and/or behavioral data, divided into first and second data sets 520, is transmitted to a backend server 540 through a first communication medium 530. The first data sets primarily contain detailed user-centric performance and behavioral information, including parameters like user age, position, performance level, playtime, projected potential level, experience, number of games played and minutes played, participation in domestic or national leagues, and contract situations. This comprehensive first dataset provides a granular view of user attributes and potential, critical for applications like scouting, analytics, and sponsorships.

The second data set 520 includes auxiliary but equally essential information such as user historical data, biometric data, fan engagement metrics, tracking data, and team performance statistics. These are often derived from multiple external sources, including third-party databases, historical archives, user profiles, team profiles, and social media platforms. By combining these with the first data sets, a complete and enriched dataset is created.

The backend server 540 serves as a processing hub where the incoming data is verified, analyzed, and stored. The backend server 540 ensures data integrity and performs transformations into structured formats with metadata that includes event, location, and time details, which are essential for contextual understanding. The backend server 540 communicates with other components through a second communication medium 550 to transfer these processed first and second data sets 520 into a centralized repository 522, ensuring data is securely stored and accessible for further use.

Both the first communication medium 530 and second communication medium 550 utilize advanced networking technologies, including, but not limited to, 5G, private 5G, 6G, Wi-Fi, BLT and beacons, Wi-Fi 6, LPWA, peer-to-peer connections, and voice-assisted systems such as Alexa, Siri, and Google Voice. The first communication medium 530 and the second communication medium 550 ensure that data transfer occurs seamlessly, securely, and with minimal latency, irrespective of the source or destination. This robust infrastructure supports real-time data flow and provides to high-bandwidth requirements critical for applications like live sports analytics, fan engagement, or dynamic advertising.

By integrating diverse data sources, communication technologies, and processing capabilities, a cohesive framework is established that enables the efficient management, analysis, and monetization of user performance and behavioral data.

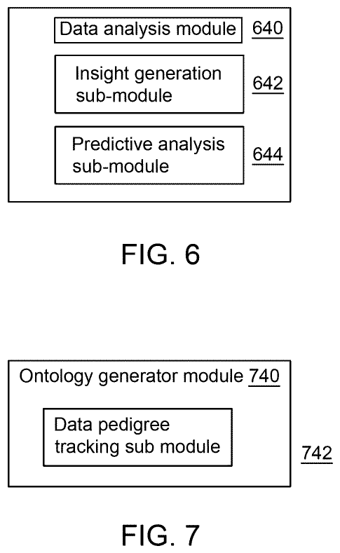

FIG. 6 depicts exemplary sub-modules of a data analytics module 640.

The data analytics module 640 is a vital part of system 100, designed to analyze vast amounts of user performance and behavioral data to uncover meaningful insights and forecasts. It is divided into two sub-modules: an insight generation sub-module 642 and a predictive analysis sub-module 644. These sub-modules work together to provide stakeholders with actionable intelligence and forward-looking projections based on user performance and behavioral data.

The insight generation sub-module 642 focuses on extracting actionable information from both the first and second data sets. By processing structured information enriched with metadata like event details, location, time, and individual identity, this sub-module identifies patterns, trends, and correlations within the data. For instance, insight generation sub-module 642 can highlight how an athlete's performance improves over successive games or pinpoint recurring behavioral patterns that impact results. The insight generation sub-module 642 is equipped with machine learning capabilities to recognize trends, assess behavioral tendencies, and provide contextual insights tailored to the needs of different stakeholders. Reports generated by the insight generation sub-module 642 are customized for diverse audiences such as coaches, scouts, and advertisers, ensuring that each stakeholder receives relevant and precise insights.

The predictive analysis sub-module 644 is designed to forecast future outcomes based on historical and real-time data. Using advanced statistical models and machine learning algorithms, the predictive analysis sub-module 644 predicts metrics such as an athlete's future performance levels, potential career milestones, and even risks like injury. The predictive analysis sub-module 644 also identifies long-term trends, offering strategic projections like an athlete's growth potential or fan engagement trajectory. The predictive analysis sub-module 644 conducts scenario analysis to simulate various conditions, such as changes in training intensity or team dynamics and predicts their potential impact on user outcomes. By providing data-driven recommendations, the predictive analysis sub-module 644 helps users and stakeholders make informed decisions to optimize performance or engagement.

Together, the two sub-modules ensure that the data analytics module 640 delivers a comprehensive understanding of user performance and behavior. The insight generation sub-module 642 identifies current trends and patterns, while the predictive analysis sub-module 644 builds upon these findings to anticipate future possibilities. This integration allows system 100 to provide stakeholders with both a detailed snapshot of current performance and strategic guidance for the future, enhancing decision-making and maximizing the value of the analyzed data.

FIG. 7 depicts an exemplary sub-module within the ontology generator module 740.

The ontology generator module 740 is a core component of the system 100, designed to categorize, structure, and contextualize the vast and diverse data ingested into the online data management and monetization platform. The ontology generator module 740 plays a pivotal role in creating a dynamic ontology, a continually evolving framework that organizes data into meaningful categories based on context, relationships, and metadata. A critical aspect of the ontology generator module 740 is a data pedigree tracking sub-module 742, which ensures comprehensive lifecycle documentation for all data points processed by the system 100.

The ontology generator module 740 receives both the first data sets (such as user-specific performance metrics) and second data sets (such as historical and biometric data) and transforms them into structured and contextualized information. By utilizing metadata, including event type, location, time, and individual identity, the ontology generator module 740 organizes the ingested data into a logical framework that stakeholders can easily interpret. This ontology evolves dynamically, incorporating new data inputs, user behaviors, and expert feedback to stay relevant and adaptable. For instance, the ontology might link a user's on-field performance metrics with historical data and fan engagement statistics, offering a complete view of the user's performance landscape.

The data tracking sub-module 742 is integral to maintaining the integrity and lineage of the ingested data. It meticulously documents the origin, transformations, and usage of each data point, creating an immutable record that tracks its entire lifecycle. This includes identifying the source of the data, such as IoT devices, social media platforms, or historical databases, and recording every step of its processing, whether through data validation, analysis, or sharing with third parties. For example, if a player's performance data is aggregated from wearable devices and later combined with historical league data for predictive analytics, the data tracking sub-module ensures that every stage of this process is recorded and traceable.

Together, the ontology generator module 740 and the data pedigree and tracking sub-module 742 provide several key benefits. They ensure transparency and accountability by allowing users and stakeholders to trace the lineage of data points back to their origin. This traceability is essential for validating data authenticity, identifying anomalies, and ensuring regulatory compliance. Furthermore, the dynamic ontology enables system 100 to adapt to new data types and contexts, making it highly versatile for various applications, such as personalized insights, predictive modeling, and targeted data monetization.

By integrating these functionalities, the ontology generator module 740 with its data pedigree and tracking sub-module 742 not only enhances the organization and usability of user performance and behavioral data but also ensures that stakeholders have access to reliable, transparent, and context-rich information. This comprehensive approach aligns with the invention's broader goal of empowering the plurality of users to manage, monetize, and derive value from their performance and behavioral data while maintaining control and transparency.

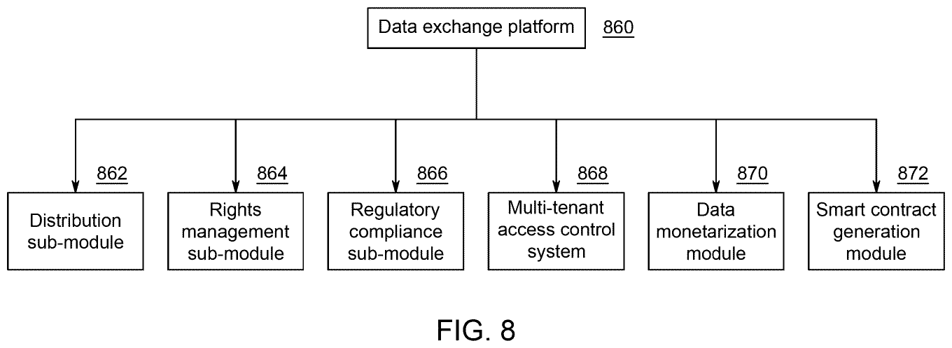

FIG. 8 depicts exemplary sub-modules within the data exchange platform 860.

The data exchange platform 860 is a critical component of system 100, serving as the hub for securely sharing, monetizing, and managing user performance and behavioral data with third parties. The data exchange platform 860 is designed to uphold transparency, user control, and compliance while ensuring fair compensation for data usage. To achieve this, the data exchange platform 860 integrates several sub-modules, each with a specific role, enabling efficient data transactions while addressing the diverse needs of stakeholders.

The distribution sub-module 862 is responsible for automating the distribution of compensation to users when their performance and/or behavioral data is accessed or utilized by third parties. For instance, when a broadcaster or advertiser purchases performance data for analysis or promotional purposes, the distribution sub-module 862 ensures that the proceeds are allocated directly to the corresponding users under pre-defined terms. Leveraging smart contract technology, the distribution sub-module 862 calculates and executes the distribution of funds transparently, minimizing disputes and ensuring fairness.

The rights management sub-module 864 governs the permissions associated with user performance and/or behavioral data. The rights management sub-module 864 provides users with granular control over how their personal and/or behavioral data is accessed and by whom. For example, a user can specify that their biometric data may be shared with a medical researcher but not with a betting company. The rights management sub-module 864 enforces these permissions during every transaction, ensuring that the user's performance and/or behavioral data usage aligns with user preferences and contractual agreements. The rights management sub-module 864 integrates with the broader system to notify users of data requests and allow them to accept or deny access in real-time.

The regulatory compliance sub-module 866 ensures that all data transactions adhere to relevant privacy and data protection regulations, such as GDPR, CCPA, or other applicable laws. The regulatory compliance sub-module 866 tracks jurisdiction-specific requirements and enforces measures like user consent, data anonymization, and audit logging. For instance, if a third party from a specific region requests data, the regulatory compliance sub-module 866 ensures that the transaction complies with the legal frameworks of that region. Additionally, regulatory compliance sub-module 866 maintains a secure and tamper-proof record of all transactions for auditing purposes.

The multi-tenant access control system 868 enables different stakeholders, such as broadcasters, advertisers, fantasy league operators, and sports analytics firms, to access the data exchange platform 860 simultaneously while maintaining strict segregation of data and permissions. Each stakeholder is assigned specific access levels based on their role and agreements with users. For example, broadcasters may only access performance statistics, whereas advertisers may require aggregated fan engagement data. The multi-tenant access control system 868 ensures that each tenant's access is isolated and secure, preventing unauthorized cross-tenant data access.

The data monetization module 870 facilitates the commercial transactions associated with user performance and/or behavioral data. The data monetization module 870 provides tools for pricing, licensing, and structuring data packages to meet the needs of different stakeholders. For example, a sports analytics company might purchase a comprehensive data package, including historical performance and biometric data, while an advertiser might only acquire fan engagement metrics. The data monetization module 870 ensures that users benefit financially from the use of their data and can participate in pricing and licensing discussions.

The smart contract generation module 872 is the backbone of secure and automated data transactions. When a third party requests data, the smart contract generation module 872 generates a smart contract that outlines the terms of the transaction, including access permissions, pricing, and data usage conditions. The smart contract is self-executing, automatically validating the request, facilitating data transfer, and triggering compensation distribution upon completion. For instance, when an advertiser purchases data, the contract ensures that only the agreed-upon data is shared and that payment is transferred instantly to the user.

Together, these sub-modules make the data exchange platform 860 a robust and comprehensive system for managing the lifecycle of data transactions. The data exchange platform 860 ensures that users retain control and benefit from their data, while third parties gain reliable access under transparent, fair, and secure terms. By integrating these functionalities, the invention achieves its goal of empowering users to monetize their performance and behavioral data while maintaining privacy, compliance, and trust.

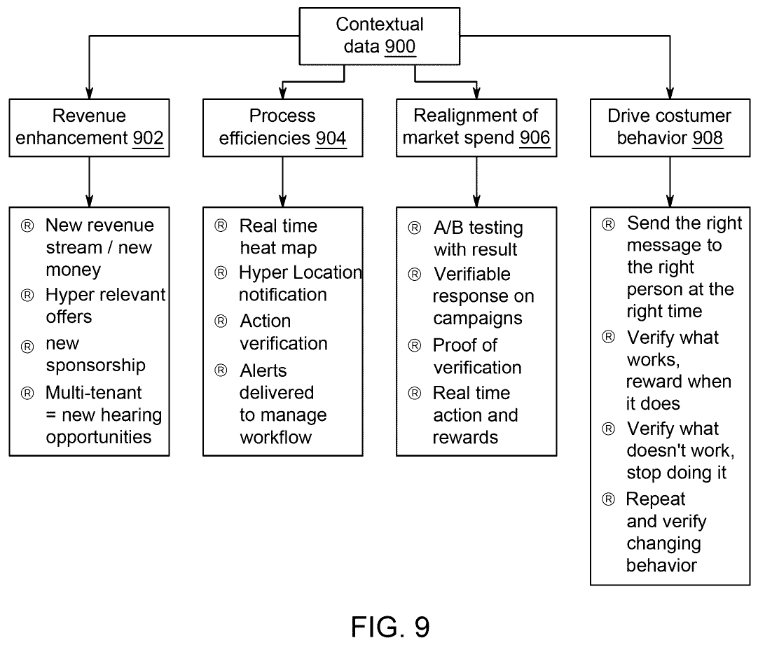

FIG. 9 depicts details of the contextualized data.

The data exchange platform is an integral component of system 100, enabling the smooth transfer of contextualized data 900 from the backend server to external entities through the second communication medium. The data exchange platform processes and delivers contextualized data, represented as parameters 900, which provide actionable insights across various operational and strategic areas. The parameters incorporate a revenue management 902, a process efficiency 904, a realignment of market spend 906, and a driving customer behavior 908, each designed to address specific business needs and maximize the utility of the collected user performance and/or behavioral data.

The revenue management 902 parameter focuses on generating and enhancing income streams by leveraging performance and behavioral insights. The revenue management 902 parameter identifies new revenue streams and opportunities to bring in additional funding. By crafting hyper-relevant offers, businesses can ensure promotions in correspondence to users that resonate deeply with individual user preferences. The revenue management 902 parameter also facilitates new sponsorship opportunities, allowing stakeholders like advertisers or sponsors to connect with highly targeted audiences. Additionally, the data exchange platform supports multi-tenant learning opportunities, enabling stakeholders to extract valuable lessons and collaboratively optimize strategies for improved outcomes.

Process efficiencies 904 are achieved by providing real-time, actionable insights to streamline workflows. Through a real-time heat map, businesses gain a visual representation of critical data points, aiding in swift decision-making. Hyper-location notifications offer precise updates relevant to specific geographic areas, improving operational responsiveness. The process efficiencies 904 parameter ensures action verification, confirming the execution and effectiveness of tasks. Moreover, alerts are delivered to manage workflows, enabling proactive adjustments to optimize processes and prevent bottlenecks.

The realignment of market spend 906 parameter focuses on optimizing marketing investments by using data-driven strategies. Through A/B testing with results, businesses can compare different approaches to identify the most effective campaigns. The realignment of market spend 906 parameters provides a verifiable response to campaigns, offering tangible proof of impact, which aids in decision-making. Proof of verification ensures the credibility of marketing outcomes, enhancing stakeholder confidence. Additionally, real-time actions and rewards allow businesses to adapt their strategies quickly and incentivize desired customer behaviors, making marketing more agile and effective.

Driving customer behavior 908 involves using users performance and/or behavioral data to shape and enhance user actions in meaningful ways. The data exchange platform ensures businesses can send the right message to the right person at the right time, maximizing the relevance and impact of communications. By analyzing responses, the driving customer behavior 908 can verify what works, reward when it does, and reinforce positive behaviors. Conversely, it identifies and stops ineffective actions, ensuring resources are not wasted. The driving customer behavior 908 continuously repeats and verifies changing behavior, creating a dynamic loop of analysis, action, and refinement to foster lasting engagement and loyalty.

This comprehensive design of the data exchange platform, with its robust sub-modules and contextualized data parameters, enables stakeholders to utilize performance and behavioral insights effectively, developing improved revenue generation, operational efficiencies, and customer satisfaction.

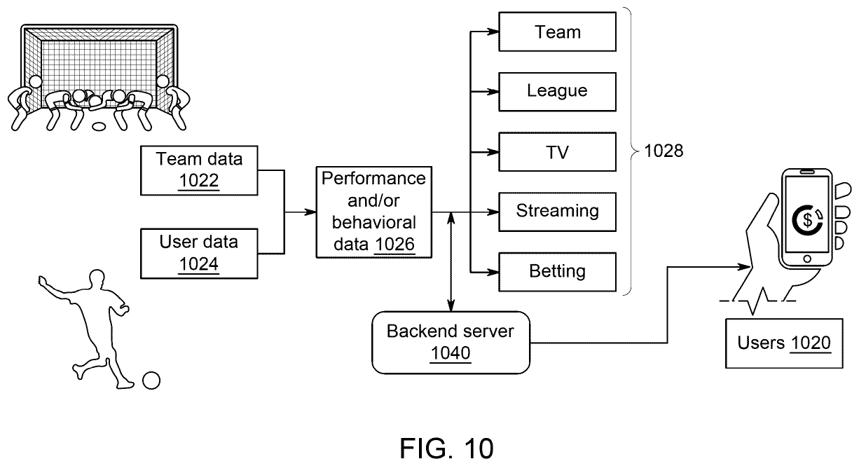

FIG. 10 depicts the relationship between the user's performance data and/or behavioral data 1026 and the backend server 1040.

The relationship between the user's personal performance and/or behavioral data 1026 and the backend server 1040, by performing management and monetization presents a transformative approach that integrates cutting-edge technology, including data capture methodologies, AI-driven analytics, and advanced Augmented Intelligence AI techniques. The relationship between the user's personal performance and/or behavioral data 1026 and the backend server 1040 is designed to collect, authenticate, analyze, and monetize personal performance data, offering athletes unprecedented control over the user's performance and behavioral data 1026 and ensuring its secure and equitable use.

The user's performance and behavioral data 1026 includes multiple information streams, including team data 1022, athlete BPM, and user data 1024. Team data 1022 comprises collective statistics and performance metrics of the athlete's team, providing a contextual backdrop for individual performance. Athlete BPM focuses on biometrics, physiological metrics, and behavior tracking to offer granular insights into the athlete's physical and psychological readiness. User data 1024 involves specific metrics such as match statistics, gameplay actions, and real-time performance indicators captured during sports events.

The online data management and monetization platform employs established data capture methods, such as wearable devices, sensors, and sports-specific monitoring equipment, to gather comprehensive datasets. These include metrics like heart rate, movement patterns, gameplay actions, and environmental data. The collected data is fed into the data analytics module, which serves as a central hub for data curation and transformation. The AI algorithms analyze raw inputs to identify actionable insights, trends, and patterns, making the data highly valuable for decision-making in areas such as training, team selection, and performance optimization.

Advanced Augmented Intelligence techniques elevate the system by enabling context-aware communication through sensors and video analysis. For example, in sports like soccer and football, video motion capture technologies recognize specific actions such as headers, passes, tackles, and corners. Using Artificial Intelligence in video image recognition, these actions are attributed to individual players by matching them with known and trained behaviors. This real-time contextual intelligence enhances the granularity and accuracy of performance tracking, creating a robust profile for each athlete.

An exemplary embodiment highlights the tradition of data tracking in sports, such as Major League Baseball (MLB), where standardized forms have transitioned from pen-and-paper to digital formats. Similarly, other sports adopt systematic methods to log individual performances. The platform builds on these traditions, using contextual AI to bridge historical methodologies with modem innovations. For example, in addition to basic statistics, AI-driven insights can detect patterns like fatigue trends, reaction times, and decision-making efficiency during matches.

Online data management and monetization offer athletes comprehensive control over their data by ensuring its authentication and integrity through a secure framework. Monetization is facilitated through the data exchange platform, which incorporates smart contracts for secure transactions. This enables athletes to share their performance data with third parties, such as broadcasters, advertisers, and team management, in exchange for compensation. The data exchange platform ensures that data is equitably monetized while maintaining adherence to privacy and regulatory standards.

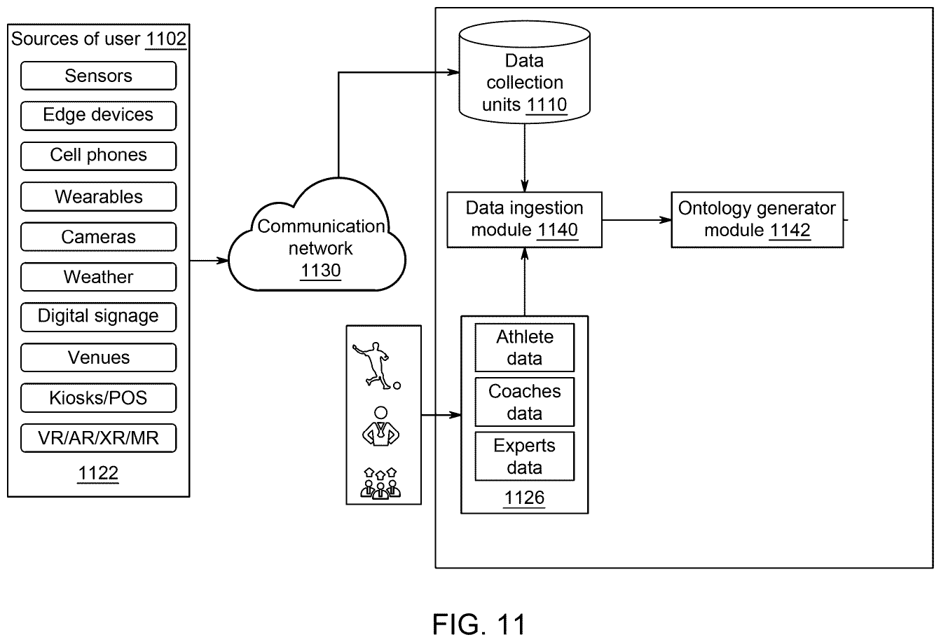

FIG. 11 depicts the generation of ontology by utilizing the user's performance data and/or behavioral data 1120.

The personal performance and/or behavioral data collection for athletes, as described, is an advanced platform that aggregates and organizes data from sources of user performance and/or behavioral data 1120, ensuring comprehensive and accurate tracking of an athlete's performance by generating the dynamic ontology. These sources of user performance and/or behavioral data 1120 include IoT sensors, edge devices, wearable technology, cameras, video recordings, automotive data, smart city sensors, weather conditions, motion tracking, and digital signage 1122. By tapping into these varied data inputs, the online data management and monetization platform creates a robust data ecosystem that captures real-time information critical for performance analysis. The multiple data streams are handled efficiently, utilizing the first communication medium 1130 to ensure fast, encrypted, and secure transmission of data. This encrypted communication, combined with data compression, ensures that large amounts of data can be shared securely via a content delivery network (CDN), preserving both data integrity and privacy.

Once the user performance and/or behavioral data 1120 is collected, it is passed to the performance data collection unit 1110, which organizes and structures the user performance and/or behavioral data 1120 into actionable insights. The online data management and monetization platform offers a unique project funding mechanism, designed to ensure that the collected user performance and/or behavioral data 1120 can be securely and effectively used within the ecosystem. The online data management and monetization platform also integrates Augmented Intelligence (AI), which combines the strengths of both human expertise and machine learning to process and analyze the performance data. Augmented Intelligence offers advanced insights by blending AI's computational power with expert knowledge, leading to more detailed interpretations of the data.

A key feature of ontology generator module 1142 is its ability to create a dynamic ontology based on the collected user performance and/or behavioral data 1120. The ontology serves as a structured knowledge framework that categorizes and contextualizes the vast array of performance data collected from various sources. Unlike traditional static ontologies, this ontology is continuously refined and evolved based on new data inputs and human insights, ensuring its relevance and adaptability. In the ontology generator module 1142, data silos are bridged by creating correlations between unstructured data from disparate sources. This makes it possible to track the ownership of data, assigning it to the correct athlete, and validating that the data was accurately recorded based on their actions.

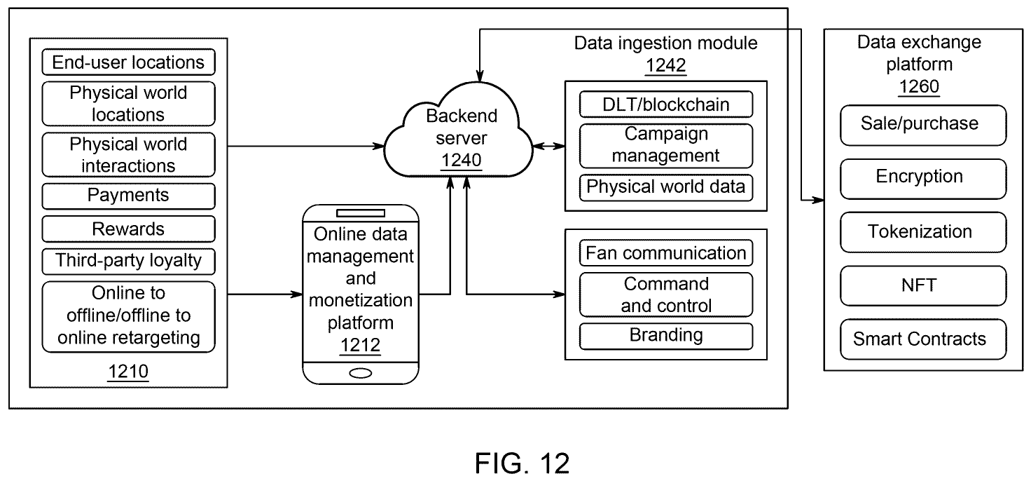

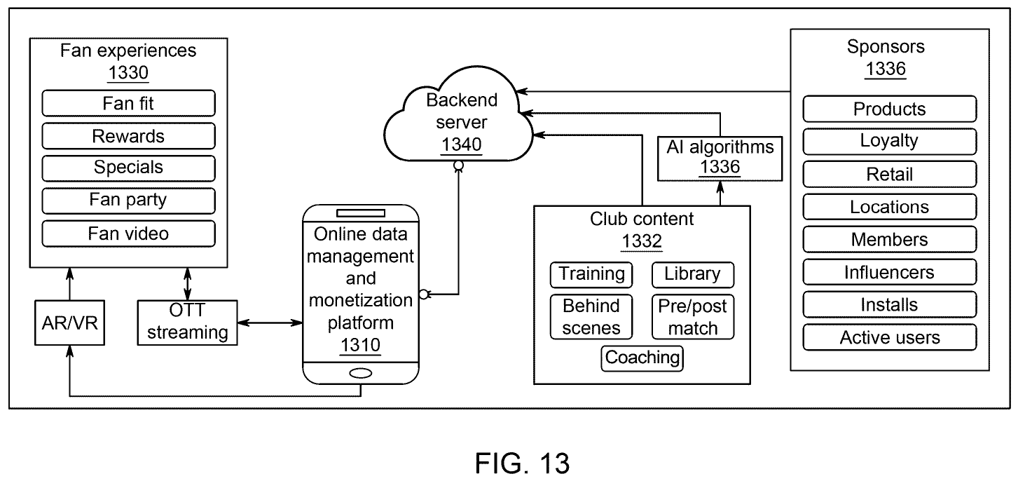

FIG. 12 depicts the collection and monetization of the user's performance and/or behavioral data 1210.

The collection and monetization of the user's performance and/or behavioral data 1210 is disclosed using a multi-layered system that facilitates the collection, management, and monetization of athlete data. The plurality of data collection units receives the user's performance and/or behavioral data 1210 across various stages, gathering data from a range of activities and interactions. This includes capturing information such as end-user locations, physical world locations, physical world interactions, payments, and rewards, and integrating data from both third-party loyalty programs and online-to-offline/offline-to-online retargeting efforts. This wide array of data points provides a complete view of the athlete's journey, linking physical, digital, and transactional interactions in real-time.

The collected user's performance and/or behavioral data 1210 is then transferred to a backend server 1240 through an online data management and monetization platform 1212. The backend server 1240 serves as the centralized hub for storing and analyzing the data. The backend server 1240 processes and aggregates the information, allowing for the generation of valuable insights such as fan interaction data, fan communication data, and branding information. The online data management and monetization platform 1212 is equipped with mechanisms to facilitate communication between fans, providing a space for offsite data exchange and comment centers, and providing an engaged and active fanbase. This part enables an enriching interaction between the athlete, their performance data, and their supporters, creating a dynamic exchange of content and information.

An essential component is the data exchange platform 1260, which acts as the central hub for the ethical trade and monetization of athlete data. The data exchange platform 1260 incorporates cutting-edge technologies such as encryption, tokenization, (NFTs) Non-Fungible Tokens, and smart contracts to securely handle transactions and rights management. The data exchange platform 1260 allows for the buying, selling, and exchange of user's performance and/or behavioral data 1210, creating a secure and transparent marketplace. Through smart contract technology, the data exchange platform 1260 automates the transfer of data rights and ensures that athletes receive fair compensation for the use of their data. These smart contracts act as binding agreements, ensuring that both data creators' athletes and data users' clubs, brands, etc. adhere to predefined terms of engagement and compensation.

FIG. 13 depicts the monetization of fan relationships by utilizing data collected from the fan experience 1330.

The monetization of fan relationships utilizes data collected from fan experiences 1330, which is used to create an innovative and profitable interaction between athletes, fans, and sponsors. The seamless exchange of data is done through a backend server 1340, ensuring that the monetization of fan relationships is efficient, transparent, and equitable.

The fan experience data 1330 is collected via online data management and monetization platform 1310, which tracks various fan interactions and engagements. The fan experience data 1330 can include a range of activities such as fan fit, rewards, specials, fan parties, fan clubs, and fan training. These data points offer a detailed view of fan behavior and preferences, providing valuable insights that help create personalized and impactful fan experiences. The fan experience data 1330 is then processed and transmitted to the backend server 1340, which serves as a central repository for all the fan-related information.

The backend server 1340 also integrates data from club content 1332 and sponsors 1336, enabling the monetization of fan relationships through targeted campaigns and offers. Sponsors 1336 provide additional content, such as advertisements or promotions, which can be generated in correspondence to the fan's preferences and behavior. The club content 1332 offers a variety of interactive and engaging materials, including training details, a library, pre/post-match content, coaching details, and behind-the-scenes content. The club content 1332 is designed to enhance the fan's connection to the athletes and the sport, further providing loyalty and engagement.

A training component within club content 1332 provides all necessary training to ensure that fans interact with the online data management and monetization platform 1310 safely and constructively. This training is important in maintaining a positive and meaningful fan experience, aligning with the goals of both the athlete and the club.

The online data management and monetization platform 1310 ensures that athletes' data is safeguarded through secure and equitable means for data monetization. It does so by adhering to transparent data management protocols, which comply with regulatory requirements and ensure that athletes retain control over their data. This system 100 respects the athletes' ownership of their data, granting them the autonomy to decide how it is used and monetized within the sports ecosystem.

In addition to data collection and monetization, system 100 integrates emerging technologies such as augmented reality AR and virtual reality VR to further enhance the fan experience. AR enriches the real world by overlaying virtual elements, allowing fans to interact with both physical and virtual objects simultaneously. VR, on the other hand, immerses the fan in a completely digital environment, providing a 360-degree interaction with the content, which can include training sessions, match highlights, and other immersive experiences. These technologies elevate fan engagement and create new revenue opportunities by offering exclusive, interactive content that fans can access and enjoy.

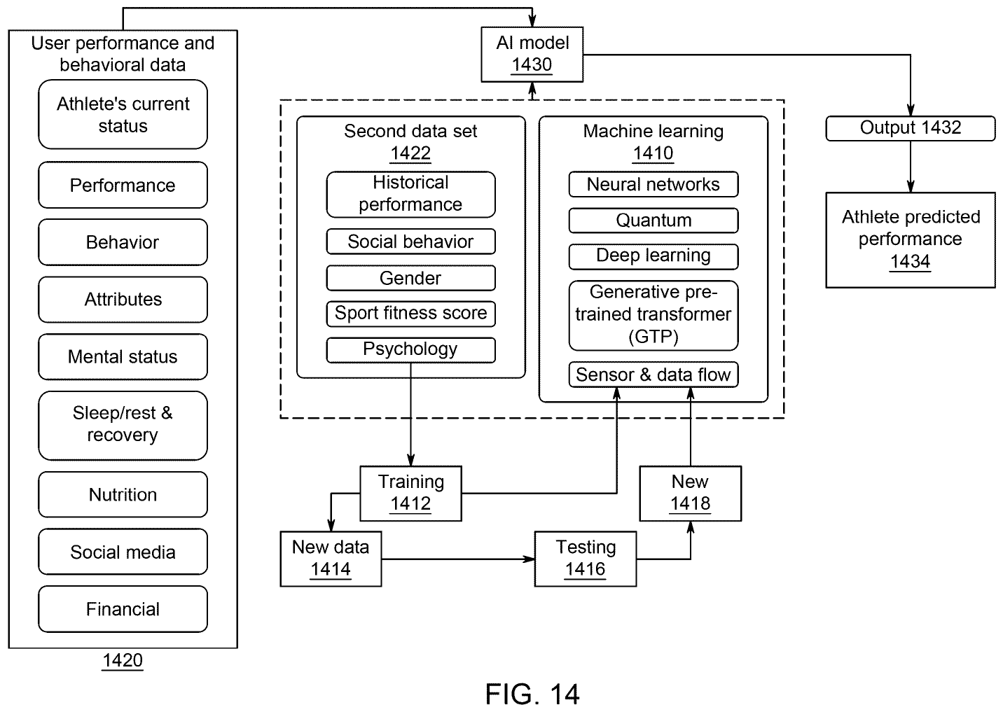

FIG. 14 depicts athletes' predicted performance 1434 based on the captured user's performance and/or behavioral data.

In the athletes' predicted performance 1434 generation based on the captured user's performance and/or behavioral data described, the core component is AI algorithms 1430 that analyze a wide range of athlete data to predict the athlete's performance. The athletes' predicted performance 1434 generation based on the captured user's performance and/or behavioral data provides an advanced method of utilizing AI algorithm 1430 to deliver accurate and insightful performance data for athletes, enabling predictive analytics for coaches, managers, and the athletes themselves. The athletes' predicted performance 1434 generation based on the captured user's performance and/or behavioral data begins by receiving the first data set 1420, which includes a comprehensive set of personal and performance-related data, such as the athlete's performance, behavior, attributes, mental status, sleep patterns, nutrition, rest and recovery, social media activity, and financial details. These data points are input into the AI algorithm 1430 to form a detailed baseline for prediction.

The next stage involves using a second data set 1422, which includes historical performance data, social behavior, gender, sports fitness score, and psychological factors. The second data set 1422 is fed into a training model 808 that enables the system to build a personalized profile for the athlete, incorporating past performance metrics and behavioral insights to create more accurate predictions. The training model 1412 serves as the foundation for machine learning, using a variety of complex algorithms and neural networks to learn from historical data and generate valuable predictions.

Once the AI algorithm 1430 is trained, the trained data is passed to machine learning techniques 1410, which includes advanced technologies such as TensorFlow, Generative Pre-Trained Transformers GPT, deep learning, quantum computing, and neural networks. The machine learning techniques 1410 are utilized to analyze vast amounts of data and produce refined predictions. New data 1414 is also integrated, which may include real-time performance metrics and additional factors that emerge during training and testing, further enhancing the AI predictive capabilities. This new data 1414 is input into a testing model 1416 to verify and refine the predictions made by the machine learning technique 1410.

Final output 1432 from the AI algorithms 1430 is the predicted performance data 1434 for the athlete, providing insights on their potential future performance based on the current status and historical data. This predictive output 1432 is essential for understanding an athlete's trajectory, adjusting training regimens, and making informed decisions about sponsorships, contracts, and team strategies.

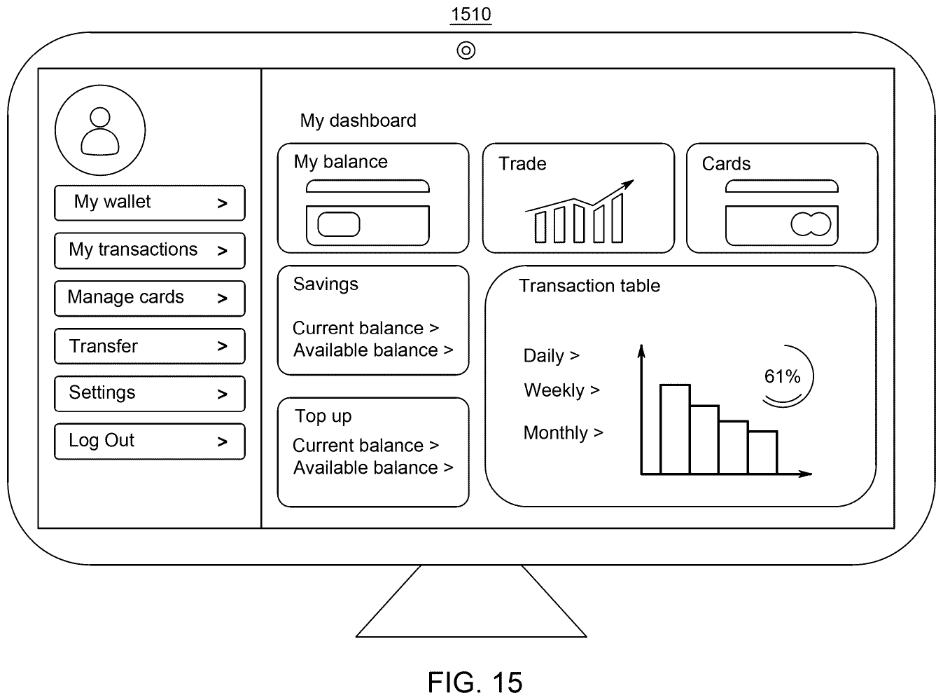

FIG. 15 depicts an exemplary user interface 1510 disclosing a finance model for athletes designed to manage and track the monetary aspects of an athlete's personal performance data and other revenue-generating activities.

The user interface 1510 illustrates a finance model for athletes and provides an integrated online data management and monetization platform designed to manage and track the monetary aspects of an athlete's personal performance data and other revenue-generating activities. The core of the financial model is the account profile, which includes several features designed to empower athletes to take control of their finances. These features encompass a dashboard, wallet, transaction management, card management, and options for transfers, settings, and logout.

The user interface 1510 offers a consolidated view of the athlete's financial status, displaying key information such as their balance, details on trade activities, card details, savings, and top-up information. This enables athletes to track the performance of their financial assets, such as data earnings or sponsorships. One of the most important components is the transaction table, which provides detailed breakdowns of financial transactions over various time frames, such as daily, weekly, and monthly, and presents them in graphical format for easier comprehension and tracking.

Through these features, athletes can effectively manage their financial data, from everyday spending to strategic investments or transfers, ensuring that their performance data is not only used for on-field success but is also a robust source of income. The online data management and monetization platform enhances transparency and provides real-time access to the athlete's financial status, offering a seamless, integrated experience for managing personal finances in connection with their performance and data monetization efforts.

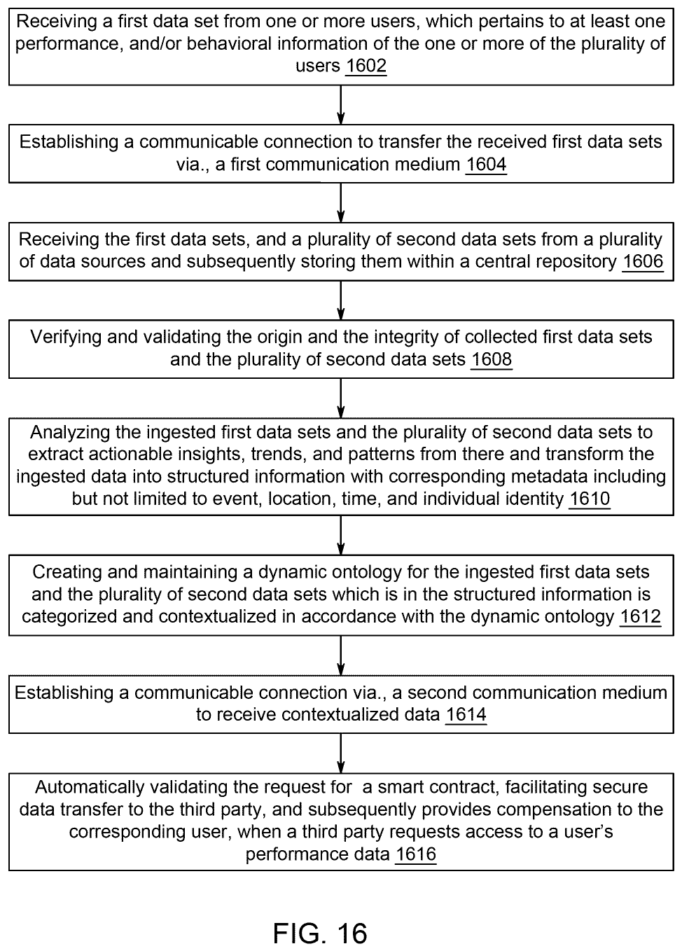

FIG. 16 depicts an exemplary process 1600 to manage and monetize a plurality of users' personal and/or behavioral data using the online data management and monetization platform.

The steps followed during the process 1600 to manage and monetize a plurality of users' personal and/or behavioral data using the online data management and monetization platform are described below in detail:

Step 1602, receives a first data set from one or more users, which pertains to at least one performance, and/or behavioral information of the one or more of the plurality of users.

The online data management and monetization platform is designed to collect, process, and utilize comprehensive performance and behavioral data from users, particularly athletes, through advanced and versatile data collection mechanisms. At its core, the online data management and monetization platform receives a first data set that includes a wide array of critical attributes such as the user's age, position, performance level, playtime, projected potential, experience, number of games played, minutes played, experience in domestic and national leagues, and contract situations. This rich dataset offers a complete view of the user's capabilities, historical performance, and future potential, making it invaluable for applications like personalized training, talent development, and data-driven decision-making in sports management.

To ensure accurate and comprehensive data capture, a plurality of data collection units is equipped with state-of-the-art technologies. These include IoT sensors embedded in equipment or worn by users for monitoring physical activities and real-time metrics, edge devices for localized data processing, and cell phones for capturing dynamic user interactions. Wearable devices track biometric and movement data, while cameras and sports-specific monitoring equipment capture real-time performance metrics. The smart city sensors, venues, kiosks, POS systems, and cutting-edge tools like VR, AR, XR, MR, and digital signage are also integrated to gather data from diverse environments.

By consolidating data from these sources, the robust data acquisition and enables the creation of actionable insights. These insights empower stakeholders such as athletes, coaches, and sports organizations to make informed decisions and maximize performance outcomes while ensuring the data is securely managed and utilized responsibly.

Step 1604, establishes a communicable connection to transfer the received first data sets via, a first communication medium.

Establishing a communicable connection to facilitate the secure and efficient transfer of the first data sets, ensuring seamless data flow across multiple devices and platforms. This is achieved through a first communication medium that employs cutting-edge technologies such as 5G, private 5G, and 6G, which provide ultra-fast, low-latency, and high-bandwidth data transmission. Additionally, Wi-Fi and WiFi-6 are utilized for high-speed wireless local area connectivity, particularly within smart venues and training environments. For short-range communication, energy-efficient technologies like Bluetooth (BLT) and beacons are employed, making them ideal for IoT and wearable devices.

For long-range and decentralized communication, Low Power Wide Area (LPWA) networks are used, enabling efficient data transfer for IoT devices with minimal power consumption. Peer-to-peer (P2P) communication further enhances communication by allowing direct data exchange between devices, reducing dependency on intermediaries, and improving privacy. Voice-based technologies such as Audio, Alexa, Siri, Google Voice, and other voice commands provide intuitive and hands-free interaction for data transfer.

In addition, the communication medium integrates Point-of-Sale (POS) systems and scanners to capture transactional and behavioral data. This diverse array of technologies ensures that the collected first data sets, comprising critical performance and behavioral information such as user age, position, playtime, experience, and more, are transmitted securely and efficiently. This process guarantees adaptability across various environments, allowing real-time data analysis and integration while maintaining encrypted and protected data handling.

Step 1606, receives the first data sets, and a plurality of second data sets from a plurality of data sources and subsequently stores them within a central repository.

Further, after receiving the first data sets, which include critical performance and behavioral information such as user age, position, level, playtime, projected potential, and more. In parallel, a plurality of second data sets is also received, enriching the overall data ecosystem with additional contextual information. The second data sets comprise user historical data, biometric data, fan engagement data, tracking data, and team performance data, offering a comprehensive view of the user's performance and behavioral attributes. These diverse data points are collected from a plurality of data sources, ensuring a robust and multi-dimensional data acquisition process.

The data sources include third-party databases that provide a wide range of information, such as historical records, user profiles, team profiles, and social media data. Historical data play a pivotal role in the system, integrating digitized historical records and scorecards to encapsulate a user's past performance data. This integration allows for deeper insights by combining past and present data, forming a foundation for predictive analytics and personalized recommendations.

Once collected, both the first and second data sets are securely stored within a centralized repository. This repository acts as the core component for organizing and preserving the data for seamless access and further processing. Advanced encryption and data management protocols ensure the security, authenticity, and integrity of the stored data, preventing unauthorized access or tampering. By unifying data from a variety of sources and formats, the central repository establishes a structured and accessible knowledge base that fuels downstream analytics, predictive modeling, and decision-making processes.

Step 1608, verification and validation of the origin and the integrity of collected first data sets and the plurality of second data sets.

Verifying and validating the origin and integrity of the collected first data sets and second data sets is a critical step in ensuring the reliability and authenticity. This begins with employing advanced data validation mechanisms that assess the source of the data. It utilizes secure data acquisition protocols to confirm that the data is collected only from trusted and authorized sources. For instance, the first data sets, comprising user performance and behavioral information, and the second data sets, which include historical data, biometric data, fan engagement data, tracking data, and team performance data, are cross-referenced with their originating data sources to confirm their authenticity.

To achieve this, the invention employs a combination of blockchain-based immutable lineage tracking and advanced cryptographic techniques. Each piece of data is tagged with metadata that captures its origin, including the specific IoT sensors, edge devices, wearable devices, or third-party databases from which it was obtained. This metadata includes timestamps, device identifiers, and source credentials, ensuring that the provenance of the data can be traced back to its source without ambiguity. The invention's claims also emphasize the use of content delivery networks (CDNs) and encrypted channels for secure data transfer, which further fortifies the validation process by preventing unauthorized interception or alteration during transmission.

Once the origin is verified, the integrity checks are conducted to ensure that the data has not been tampered with. This involves applying hashing algorithms and checksum validations that detect discrepancies or changes in the data. For historical records, such as digitized scorecards or social media data, are compared with received data with archived records to ensure consistency.

This rigorous verification and validation process ensures that only accurate, untampered, and authentic data is stored and used within the central repository, By maintaining high standards of data quality and integrity, it is ensured that the reliable downstream analytics, predictive modeling, and monetization opportunities, enable stakeholders to confidently utilize the data for various applications.

Step 1610, analysis of the ingested first data sets and the plurality of second data sets to extract actionable insights, trends, and patterns from there and transform the ingested data into structured information with corresponding metadata including but not limited to event, location, time, and individual identity.

Analyzing the ingested first data sets and the plurality of second data sets to extract actionable insights, trends, and patterns involves leveraging advanced data analytics techniques and AI-driven methodologies. This step begins with the integration of diverse datasets collected from multiple sources, such as IoT sensors, wearable devices, cameras, historical records, social media data, and third-party databases. The first data sets typically include performance and behavioral information of users, while the second data sets encompass historical data, biometric information, fan engagement data, tracking details, and team performance metrics.

Once ingested, the AI-powered data processing engines to standardize and organize the data into structured formats. This involves eliminating redundancies, resolving inconsistencies, and ensuring that data from disparate sources can be seamlessly integrated. The invention uses a dynamic ontology framework to categorize and contextualize this data, transforming it into structured information with corresponding metadata. The metadata includes critical attributes such as the event associated with the data, the location where the data was captured, the timestamp of the data collection, and the individual identity of the subject involved.

Further, the machine learning algorithms are also utilized, such as deep learning and neural networks, to analyze patterns within the data. For instance, athlete performance data might reveal trends in physical fitness improvements over time, correlations between rest periods and performance metrics, or predictive insights into future performance potential. Similarly, fan engagement data might identify patterns in audience behavior, preferred content formats, or interaction frequencies, which can be used to optimize fan experiences or sponsorship strategies.

Advanced AI models also integrate contextual intelligence, enabling the analysis to consider the situational context of the data. For example, location metadata might help identify performance variations across venues, while timestamps could highlight peak activity periods or periods of high performance. Behavioral analysis further correlates individual identity with specific events, such as an athlete's movements during a match or fan interactions during a live event.

The invention ensures that the extracted insights are not only actionable but also secure and traceable. Blockchain-based tagging mechanisms provide immutable lineage and pedigree for the metadata, documenting the origin, transformations, and analyses performed on the data.

Step 1612, create and maintain a dynamic ontology for the ingested first data sets, and the plurality of second data sets which is in the structured information is categorized and contextualized in accordance with the dynamic ontology.

Creating and maintaining a dynamic ontology for the ingested first data sets and the plurality of second data sets involves developing an evolving framework that categorizes, contextualizes, and enriches structured information. This step is pivotal for organizing vast and complex datasets into a coherent and actionable knowledge structure, ensuring that the data is both accessible and meaningful for various stakeholders.

Initially, the ingested data, comprising first data sets (performance and behavioral information) and second data sets (historical data, biometric data, fan engagement data, tracking data, and team performance data), is transformed into structured formats using advanced AI and machine learning algorithms. This structured information includes metadata attributes such as event, location, time, and individual identity, which provide context to the raw data.

A dynamic ontology framework is applied to organize this structured information. The ontology serves as a living, evolving knowledge model that defines relationships, hierarchies, and classifications within the data. For example, in the context of athlete performance, the ontology might link metadata such as “event” to specific game scenarios, “location” to venues, and “individual identity” to player roles or positions. Similarly, fan engagement data might be categorized under “behavioral insights,” linking fan interaction patterns with specific events or campaigns.

The dynamic ontology is maintained and continuously refined through a combination of automated machine-learning models and human expertise. Advanced AI techniques, such as natural language processing (NLP) and deep learning, identify emerging patterns, trends, or anomalies within the data, prompting updates to the ontology. Human input ensures that domain-specific nuances and contextual factors are accurately captured, enhancing the ontology's relevance and usability.

This evolving ontology framework not only categorizes data but also contextualizes it by creating connections between disparate data silos. For example, it might correlate an athlete's biometric data with historical performance trends, or link fan engagement metrics with sponsorship effectiveness. This contextualization enables the system to derive deeper insights, such as identifying key performance drivers for athletes or optimal fan engagement strategies for sponsors.

Furthermore, the invention integrates governance mechanisms to ensure the integrity and traceability of the ontology. Each update or modification to the ontology is logged, creating an immutable record of its evolution. This aligns with claims emphasizing data authenticity, secure management, and compliance with regulatory standards.

By creating and maintaining a dynamic ontology, the system empowers users with a structured and contextualized view of data, enabling informed decision-making. This framework supports a wide range of applications, from predictive analytics and personalized recommendations to strategic planning and monetization of data assets, ensuring that the information remains actionable, relevant, and aligned with stakeholder goals.

Step 1614, establishes a communicable connection via, a second communication medium to receive contextualized data.

Establishing a communicable connection via a second communication medium to receive contextualized data ensures the seamless and secure transfer of structured and meaningful information across interconnected systems. This process utilizes advanced communication technologies to enable real-time data exchange, supporting various applications such as analytics, decision-making, and personalized services.

Initially, the required endpoints and devices are identified as involved in the communication network. These endpoints could include backend servers, edge devices, IoT sensors, or user-facing interfaces such as mobile applications or smart devices. Once the endpoints are determined, a communicable connection is established using a second communication medium. The second medium encompasses a range of advanced technologies, including 5G, private 5G, 6G, Wi-Fi, BLT (Bluetooth Low Energy) and beacons, WiFi-6, Low Power Wide Area (LPWA) networks, peer-to-peer connections, and voice-based assistants like Alexa, Siri, and Google Voice. Additionally, traditional systems such as POS terminals and scanners may also be integrated into the communication network.

The selection of the appropriate communication technology is based on the specific use case, ensuring high-speed, reliable, and secure data transfer. For example, 5G and 6G technologies provide ultra-low latency and high bandwidth for transmitting large volumes of contextualized data in real-time. In contrast, LPWA and Bluetooth are more suitable for low-power devices or short-range communication. Voice assistants and peer-to-peer connections offer flexibility for user interaction and direct device-to-device communication.

Once the connection is established, the contextualized data is transmitted from the source to the destination. Contextualized data includes metadata-enriched structured information, such as event details, location, timestamps, and associated identifiers like individual or device IDs. This ensures that the data is not only accurate but also meaningful for downstream processing and analysis.

The process incorporates encryption, compression, and secure communication protocols to safeguard data integrity and privacy during transmission. Encryption ensures that the data is accessible only to authorized parties, while compression optimizes data packets for efficient transfer. These mechanisms align with the invention's claims of maintaining robust data security, authenticity, and compliance with regulatory standards.

By leveraging the second communication medium, the uninterrupted and efficient data flow is ensured, enabling various functionalities such as real-time analytics, dynamic updates, and actionable insights. This process plays a critical role in supporting applications like athlete performance monitoring, fan engagement, and financial management, enhancing the overall value and utility of the platform.

Step 1616, automatically validates the request for a smart contract, facilitating secure data transfer to the third party, and subsequently provides compensation to the corresponding user, when a third party requests access to a user's performance data.

Validating a request for a smart contract, facilitating secure data transfer to a third party, and subsequently providing compensation to the corresponding user is a crucial aspect of ensuring secure, transparent, and equitable data usage within the online data management and monetization platform. When a third party requests access to a user's performance data, a validation process is initiated to ensure the legitimacy and authenticity of the request.

The first step involves receiving the third-party request for access to the user's performance data. The request is validated through an automated process that checks for compliance with predefined rules and conditions, such as user consent, data ownership, and usage rights. The smart contract mechanism ensures that both parties, the user and the third party, are bound by terms that are transparent, automated, and enforceable. Once the request is verified, a secure data transfer mechanism is triggered, ensuring that the user's performance data is shared securely with the third party. This data transfer is encrypted and protected against unauthorized access, guaranteeing the confidentiality and integrity of the user's data.

At the same time, it is ensured that the user is compensated appropriately for the use of their data. Compensation terms are pre-defined in the smart contract, which automatically calculates and distributes the agreed-upon rewards, such as monetary payments, tokens, or other forms of value. This ensures a fair exchange of value, where users receive compensation for the usage of their personal performance data.

To maintain transparency and accountability, the plurality of users is notified about any requests for access to their performance data. These notifications inform users of the access request, the proposed usage agreement, and any terms associated with the data sharing. Additionally, if any anomalies or unauthorized access attempts are detected, then real-time alerts are provided to both the user and the system administrators. This helps ensure that no unauthorized party can access or misuse the user performance data and that any suspicious activity is immediately flagged for further investigation.

A user interface integrated within the online data management and monetization platform allows users to actively engage with their data. Through the user interface, users can view detailed information about their data lineage and transformation history, which includes a record of how their data has been used, shared, and modified over time. Users have full control over access to their data, with the option to authorize or deny access requests. This empowers users to make informed decisions about who can access their performance data and under what conditions, further reinforcing the principles of data ownership and privacy.

By automating these processes and integrating them into a seamless user interface, the system ensures that the user's data remains secure, their rights are respected, and they are fairly compensated for their data usage. This approach aligns with the invention's focus on transparent data management, smart contract automation, and user empowerment within the context of performance data monetization and management.

### INDUSTRIAL APPLICATIONS

The system 100 to manage and monetize a plurality of users' personal and/or behavioral data using the online data management and monetization platform 104 has significant industrial applications across various domains, particularly in sports, fitness, and data-driven analytics. By empowering individuals, especially athletes, to manage, control, and monetize their performance and behavioral data, the system 100 to manage and monetize a plurality of user's personal and/or behavioral data using the online data management and monetization platform 102 addresses critical industry needs such as transparency, security, and equitable compensation. The primary industrial application lies in the sports ecosystem, where data related to athlete performance is increasingly used by stakeholders, including teams, leagues, advertisers, broadcasters, betting companies, analytics firms, and video game developers.

The system 100 to manage and monetize a plurality of user's personal and/or behavioral data using the online data management and monetization platform 102 collects and analyzes performance data through advanced wearables, sensors, and AI-powered systems, making it indispensable for exploring talent, crafting personalized training programs, and conducting in-depth performance reviews. The ability of the system 100 to manage and monetize a plurality of user's personal and/or behavioral data using the online data management and monetization platform 102 to securely authenticate, store, and share data while maintaining a verifiable pedigree and lineage ensures its reliability for industrial use cases like predictive analytics and performance forecasting.

Additionally, the system 100 to manage and monetize a plurality of user's personal and/or behavioral data using the online data management and monetization platform 102 incorporates smart contracts and revolutionizes the monetization process by facilitating secure, automated transactions with third-party data consumers. For industries reliant on consumer behavior analysis, such as advertising and targeted marketing, the structured, verified data delivered by this system 100 to manage and monetize a plurality of user's personal and/or behavioral data using the online data management and monetization platform 102 enhances decision-making and campaign effectiveness. Broadcasters and streaming platforms can also utilize the present invention to enrich content with contextualized insights, adding value for viewers while compensating athletes fairly.

The system 100 to manage and monetize a plurality of users' personal and/or behavioral data using the online data management and monetization platform 102 utilizes robust compliance mechanisms to further extend its industrial applicability by adhering to data protection regulations like GDPR, making it suitable for global markets. Beyond sports, the system 100 to manage and monetize a plurality of users' personal and/or behavioral data using the online data management and monetization platform 102 can be adapted to other industries, including healthcare and corporate training, where performance data plays a critical role.

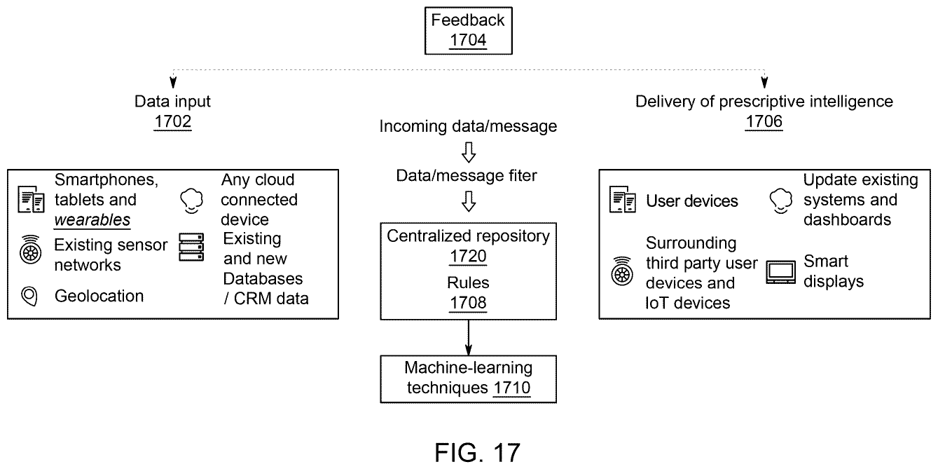

FIG. 17 depicts an exemplary embodiment utilizing data input 1702 to generate an output using various machine learning techniques 1710.

The system 100 incorporates a robust mechanism for data input and analysis, receiving input 1702 from a diverse array of sources such as smartphones, tablets, wearables, geolocation services, sensor networks, and both existing and new databases or CRM systems. This vast network of data sources ensures comprehensive coverage and real-time data acquisition. The collected data input 1702 is then filtered and securely stored in a centralized repository 1720, where predefined rules and regulations are applied to maintain data integrity and compliance. Advanced machine learning techniques 1710, including multilayer analytics, big data processing, and compliance-integrated protocols like KYC and AML, are employed to process and analyze the data. These techniques also leverage innovative mechanisms such as proof-of-resource (POR) mining and blockchain publishing to ensure secure and efficient data handling.

The processed data generates outputs 1706 that deliver actionable and perspective intelligence in correspondence to the user's needs. This output is distributed to various endpoints, including user devices, smart displays, IoT devices, third-party systems, and updated dashboards, ensuring seamless integration into existing systems. Feedback 1704 is provided in real-time to enhance user interaction and decision-making. Acting as a central nervous system, the machine learning repository 1710 integrates input from sensor networks, connected devices, and contextual user information. This enables dynamic and segmented content delivery, ensuring that the system 100 adapts to changing user needs and contexts while maintaining accuracy and relevance in its output.

The embodiments herein and the various features and advantageous details are explained concerning the non-limiting embodiments in the following description. Descriptions of well-known components and processing techniques are omitted to not unnecessarily obscure the embodiments herein The examples used herein are intended merely to facilitate an understanding of how the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles, or the like that has been included in this specification is solely to provide a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions, or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation,

We claim:

1. A system for managing and monetizing performance data for a plurality of users, the system comprising:
one or more processors;
one or more databases, operatively coupled to the one or more processors that when executed cause the one or more processors to perform operations comprising:
a plurality of data-collection units, each adapted to receive a first data set from one or more users, wherein the received data set pertaining to at least one performance, and/or behavioral information of the one or more of the plurality of users;
a back-end server communicably connected to the one or more data collection units via a first communication medium, the back-end server comprising:
a data ingestion module adapted to receive the first data sets from the plurality of data collection units, and a plurality of second data sets from a plurality of data sources, in a real time and subsequently stored within a central repository;
a data authentication module adapted to verify and validate the origin and the integrity of collected first data sets and the plurality of second data sets;
a data analysis module adapted to analyze the ingested data sets to extract actionable insights, trends, and patterns from there and transform the ingested data into structured information with corresponding metadata including but not limited to event, location, time, and individual identity;
an ontology generator module adapted to create and maintain a dynamic ontology for the ingested data sets in a real time, wherein the structured information is categorized and contextualized in accordance with the dynamic ontology;
a data exchange platform communicably connected to the backend server via a second communication medium, the data exchange platform adapted to receive contextualized data from the backend server;
characterized in that, when a third party requests access to a user's performance data, the data exchange platform automatically executes a smart contract, validates the request, facilitates secure data transfer to the third party, and compensates the corresponding user.

2. The system of claim 1, wherein the first data sets include at least one performance, and/or behavioral information, including, user age, position, performance, level, playtime, projected potential level, experience, number of games played, number of minutes played, experience in domestic/national leagues, and contract situation.

3. The system of claim 1, wherein the plurality of data collection units includes but is not limited to IoT sensors, edge devices, cell phones, wearable devices, cameras, sports-specific monitoring equipment for real-time metrics capture, smart city sensors, venues, kiosks, POS, VR, AR, XR, MR, and digital signage.

4. The system of claim 1, wherein the second data sets include user historical data, biometric data, fan engagement data, tracking data, and team performance data.

5. The system of claim 1, wherein the plurality of data sources includes various user information database selected from but not limited to historical performance databases, user profiles databases, team profiles databases, social media databases and any other third party data-sources.

6. The system of claim 1, wherein the first and second communication medium include 5G, private 5G, 6G, Wi-Fi, BLT and beacons, WiFi-6, LPWA, Peer to Peer, Audio, Voice, Alexa, Siri, Google Voice, POS, and Scanners.

7. The system of claim 1, wherein the ontology generator module comprises a data pedigree tracking submodule adapted to document a complete lifecycle of ingested data sets, wherein the ontology evolves based on continuous input from both AI analysis and human expertise.

8. The system of claim 1 wherein the generated dynamic ontology continuously evolves based on updated user personal data, user behavioral data inputs, and human expert feedback.

9. The system of claim 1, wherein the ontology generator module collaborates with human experts to refine the ontology associated with the first data sets and second data sets.

10. The system of claim 1, wherein the data exchange platform further comprises:
a proceeds distribution sub-module adapted to distribute compensation automatically to data owners;
a rights management sub-module adapted to control data access permissions;
a regulatory compliance sub-module adapted to ensure adherence to privacy laws;
wherein all data transactions are recorded on a blockchain for transparency and accountability.

11. The system of claim 1, wherein the data exchange platform further comprises:
a multi-tenant access control system adapted to manage a stakeholder access levels;
a data monetization module adapted to facilitate various transaction types;
a smart contract generation module adapted to automate data usage agreements;
wherein each stakeholder's access and usage rights are clearly defined and enforced.

12. The system of claim 11, wherein the stakeholders include broadcasters, betting entities, bookmakers, fantasy leagues, streamers, radio, and social media networks as well as advertisers, promoters, sponsors, and anyone else involved with the sport.

13. The system of claim 1, wherein the data analysis module comprises:
an insights generation sub-module adapted to identify patterns and trends;
a predictive analytics sub-module adapted to forecast performance metrics, wherein the processed data maintains its connection to the source of the user's profile.

14. The system of claim 1 further comprises a notification module notifying the plurality of users about the user's performance data access requests and proposed usage agreements, and any detected anomalies or unauthorized access attempts.

15. The system of claim 1 further comprises a user interface integrated within an online data management and monetization platform that allows the plurality of users to view, authorize, or deny access to their data lineage and transformation history.

16. A method for managing and monetizing performance data for a plurality of users, the method comprising:
executing code using one or more processors of a computer system to cause the computer system to perform operations comprising:
receiving a first data set from one or more users, wherein the received first data set pertaining to at least one performance, and/or behavioral information of the one or more of the plurality of users;
establishing a communicable connection to transfer the received first data sets via, a first communication medium, comprising:
receiving the first data sets, and a plurality of second data sets from a plurality of data sources and subsequently storing them within a central repository;
verifying and validating the origin and the integrity of collected first data sets and the plurality of second data sets;
analyzing the ingested first data sets and the plurality of second data sets to extract actionable insights, trends, and patterns from there and transform the ingested data into structured information with corresponding metadata including but not limited to event, location, time, and individual identity;
creating and maintaining a dynamic ontology for the ingested first data sets and the plurality of second data sets, wherein the structured information is categorized and contextualized in accordance with the dynamic ontology;
establishing a communicable connection via, a second communication medium to receive contextualized data;
characterized in that, when a third party requests access to a user's performance data, a smart contract is automatically executed that validates the request, facilitates secure data transfer to the third party, and subsequently provides compensation to the corresponding user.

17. The method of claim 16 further comprises notifying the plurality of users about the user's performance data access requests and proposed usage agreements, and any detected anomalies or unauthorized access attempts.
